(19) United States
(12) Patent Application Publication
(10) Pub. No.: US 2024/0303647 A1
(43) Pub. Date: Sep. 12, 2024

(54) Nonfungible Token and Digital Item Trading Infrastructure and Distributed Ledger

(71) Applicant: Alexandra V Henderson, Dallas, TX (US)

(72) Inventor: Alexandra V Henderson, Dallas, TX (US)

(21) Appl. No.: 18/180,102

(22) Filed: Mar. 7, 2023

(51) Int. Cl. G06Q 20/38; G06Q 30/08

(52) U.S. Cl. CPC G06Q 20/389; G06Q 30/08; G06Q 50/167

(57) ABSTRACT

This is a blockchain trading platform for digital items that may or may not represent real/world physical objects, real/world physical space, augmented reality game digital products, or the likeness of a person, that may or may not be further represented as nonfungible tokens traded within a temporal blockchain, a directed acyclic graph (local blockchain), a blockchain, or a multichain infrastructure, wherein the buying power of a digital currency is inflated or deflated according to a dataset valuation method which monetizes datasets that define a target audience.

### RELATED APPLICATIONS

The present application is a continuation in part of the U.S. patent application Ser. No. 17/249,683, entitled “POP-UP RETAIL FRANCHISING AND COMPLEX ECONOMIC SYSTEM,” filed on Mar. 8, 2021, which is incorporated by reference.

### FIELD OF INVENTION

This system is directed to the trading of nonfungible tokens as digital items that are the digital renditions, imagery, audiovisual content, digital replications, or scaled virtualizations of physical or real-world objects, real estate, land parcels, floorspace sectors, shelf space, commercial space, augmented reality game digital products, or the digital likeness of a person, providing scalable solutions for the complex pop-up retail and/or pop-up event needs of small business retailers and multinational commercial enterprises.

### BACKGROUND

Typically, retail space is sold via traditional real estate transactions which leaves little room for presales and event planning based on predictive modeling. Retail event planning involves the procurement of retail space, the staging or planning of procured retail space, the hiring of contractors, the hiring of management personnel, the shipment of product inventory, the staging of product inventory displays, advertising the event to a targeted audience, selecting a social media influencer to market the product or event to a broad audience that may not include many individuals that represent the retailer's consumer market, and so on. What is lacking in this process is data, more specifically, a data valuation model that would greatly reduce the risk of paying to participate in an event or of building a storefront at a location with a general population that doesn't adequately represent a targeted audience, for a price that doesn't allow for a return on the investment. There is also no known technology for accurately pricing the services of a social influencer. A retailer or online business might find themselves paying exorbitant prices for influencer promotions, without knowing how much of their followers and comments are from bot pages. Retailers also face the issue of not being able to test markets in different geographical locations and are limited to traditional means of advertising that bombard and annoy consumers and that don't typically produce traffic.

### OVERVIEW

This technology is an improvement upon traditional retail franchising and startup mechanisms that offer antiquated methods of reaching consumers. This system provides a method for launching temporary retail storefronts and social-commerce events in geophysical locations that are indicated to have a high concentration of a targeted market relative to population density and demography data extractions. Stochastic modeling using highway topography, predictive modeling, footfall data, and real estate listing data are implemented in a programmable mechanism for pinpointing locations that are optimal for temporary retail storefronts or social commerce events. Interactive virtual reality technology creates a virtual building design environment for the modified computer aided design experience for the customization and design of an event venue or retail storefront, using an interactive background that is a virtual rendition of a real-world retail space or land parcel that is listed for sale online. The “interior” virtual design and staging phase is a programmable mechanism that includes an online product repository of furnishing and product display items that can be added onto the virtual interior background in the virtual reality setting that can then be stocked with virtual renditions of real-world product items uploaded from the criterial entries and/or a merchant-to-consumer website associated with the user profile. The interior design phase further includes a method of indicating sectors of a shelving product or sectors of floorspace within the virtual design environment, as a method of minting a nonfungible token and initiating a presale of commercial shelf space or floorspace that is thereby made available for purchase by a plurality of registered users (retailers) seeking to test a product at a prospective event location. Furthermore, this system offers augmented reality advertising solutions that would create an immersive experience for a targeted audience, as well as a platform for influencers to sell their digital likeness to retailers as augmented reality advertising content or other types of digital ad content.

The system further includes a method by which retailer users may purchase an augmented reality game as part of the immersive experience offered at a pop-up event or shop.

### SUMMARY

This system converts digital items, metadata, imagery, video content, audiovisual content, or virtualizations of geophysical space, real estate, real-world/physical items, the digital likeness of persons, computer readable criterion that describe the skill sets of personnel, or real-world/physical space, into nonfungible tokens (NFT) that are assigned a computer readable monetary value according to a dataset valuation model wherein the method includes the monetization of datasets. Such datasets may be mined in the computer readable implementation of methods and technologies such as but not limited to, the georeferencing of various population densities or target markets via the programmable implementation, or the programmable interoperation, or via the integration of techniques or technologies such as but not limited to, opensource distributed computing frameworks, cloud-based geostatistics, computer readable geospatial demographics, cloud-based data analytics, cloud-based API data engineering technology, machine learning algorithms, cookie compliance data, campaign management analytics technology, social graph technology, computer readable user statistics, computer readable conversation tracking data, computer readable demographic data, serosurveillance technology, computer readable spatial analysis data, biometric surveillance technology, sentinel surveillance technology, user behavior tracking technology, relative predictive modeling, spatiotemporal data engineering, computer readable temporal querying data, computer readable polling data, programmable footfall data engineering, web scraping, web crawling, digital identification systems, API communication protocols or any variation or combination thereof from public or private sources. The datasets thereof representing a target market (or target consumer market), a consumer market, or a constituency associated with a user profile, a user profile representing a retail business owner or a retail business owner representative, or a retail business owner representative of a joint-user account, that may further be defined as buyer or seller of a nonfungible token within a virtual auction or virtual sales environment according to computer readable instructions.

The said virtual NFT auction environment embodiment, may or may not include a temporal blockchain auction platform. A temporal blockchain is to be understood as a network with a “deletable” or temporary blockchain wherein data is stored in user device nodes. This embodiment may further include auction specific single use tokens wherein each single use token is associated with a single temporal blockchain, and wherein each auction of the auction environment is associated with a single temporal blockchain. The said NFT auction environment thereby consists of a plurality of temporal blockchains and virtual auction spaces wherein a single auction space may comprise a plurality of listings (also called “lots”) of a single temporal blockchain. The method may further include a computer readable bid weighting mechanism by which criterial inputs define a preferred bidder relative to the criterial entries of a user profile, a user profile representing a bidder, by which auction specific single use tokens are relatively priced for auction participation as part of the programmable token output process.

The method further includes an embodiment for the trading of retail space, retail floorspace sectors, or retail shelf space wherein retail space, retail floorspace sectors or retail shelf space may be sold as digital items that are virtual renditions, imagery, or metadata, imported or translated from a building information model of a design computing device, or from a computer assisted design technology, or from a virtual design environment, or from an online product repository. Such digital items, metadata, or virtual renditions may represent real-world objects or may be rendered as interactive or non-interactive scaled virtualizations, or digital replicas, of said shelf space, or of said floorspace sectors, or of said retail space(s), which are associated with a cryptographic hash function and thereby further represent a nonfungible token within a virtual auction or sales environment.

The method further comprising social graph technology wherein user registration criteria is implemented in the identification of a target market that is defined according to computer readable trends in online products sales generating a consumer profile, trends in online product shipping that may generate geographic demand heat maps of a geographic information system (GIS), social media user behavioral data that may generate a social media constituency profile, and other online user behavioral models, demography data, consumer price index data, gross domestic product (GDP) data, as well as other data extracts that may be implemented to identify a target market within a predictive model. The data extractions detailing a target market that are associated with a user profile, may then be implemented to generate a social graph that relatively connects users according to user profile criteria and target market profile data correlations. This method may further be implemented in the generation of a social platform and/or media viewer shopping environment for the shopping and viewing of prospective events or shops, event or shop information and prospective shop or event venues, venues that are in escrow or that have already been procured by a user account holder, and for the trading of relatively larger percentages of venue space in the programmable facilitation of co-sponsorships in the cosponsored launch of events. A co-sponsorship is defined in this context as such but not limited to a joint user experience in the virtual building and design phase, the joint launching of targeted ad campaigns, and the dividing of ticket sales between users. A co-sponsorship may or may not further be defined as the procurement of a space by a secondary buyer, wherein the space takes up 30% or more of the total prospective venue space, or wherein the amount paid is equal in value to 30% or more of the venue value or event launch cost, whereby the listing of spaces that are 30% or more of a prospective venue space may be listed as a “co-sponsorship” NFT within the said auction or sales environment.

Social graph technology is further implemented as a method of generating a shopping experience within a virtual auction or sales environment, wherein digital item listings or auction lots that represent nonfungible tokens, are optimized according to user profile data correlations within a plurality of users, data correlations that may identify a shared target market or other trends and patterns shared between a plurality of user profiles. For example, the system may optimize the presentation of digital items during the shopping experience within the said virtual auction or sales environment, to show items from sellers with correlations in target market data or user profile criteria. Correlations such as but not limited to a relatively shared target market between two or more users in a seller-buyer (or bidder) dynamic relationship of a said virtual auction or sales environment, a relatively high consumer purchase pairing rate of products associated with the merchant-to-consumer websites of two or more user profiles that are engaged in a seller-buyer (or bidder) dynamic relationship of a said virtual auction or sales environment, or two or more user profiles of a seller-buyer (or bidder) dynamic relationship of a said virtual auction or sales environment that are registered under the same business or product category(s).

User profile data is further implemented in a bid-weighting method, wherein a seller-preferred bidder or purchaser is defined according to default or favorable dataset selection items that define a preferred bidder or preferred purchaser user profile, or that define a preferred target market whereby a weight may be applied to a bid associated with a profile that may be relatively delineated by defaulted or favorable dataset selection items. The said application of a bid-weight may or may not be represented in the pricing of a single use token within a temporal blockchain or, may or may not be implemented in the artificial inflation or deflation of a monetary unit as part of a dataset valuation method. For example, if a registered user representing the seller of an NFT in an online auction has a user profile associated with a target market defined as women between the ages of 25 and 35 years old which makes up 27% of the demographic within the prospective location of a pop-up event or retail shop, and this same seller has applied a bid-weight reflecting this dataset to the bid offer amount from all bidders with a relatively matching target market, one U.S. dollar ($1.00) offered in a bid by a preferred bidder would be worth $1.27 wherein the deflated decimal currency value represents the demographic percentage of the population within the prospective event location that represents the target market. Therefore, a bidder with a target market that does not match the preferred criteria may have to outbid a preferred bidder by up to 27 cents per dollar offered in a bid placed by the preferred bidder, according to computer readable instructions.

When the digital item being sold as a nonfungible token represents physical/real-world retail space, physical/real-world commercial floorspace, or physical/real-world shelf space, then the metadata or cryptographic hash value of the item may also include geocode data, or data that indicates a geophysical location. This geocode data, or other geo-specific data may be implemented in a correlative data analysis that compares geo-specific demography data to the target market profile data of registered users, as a means of further optimizing the order in which digital items are presented to a user during the NFT of digital item shopping experience. For example, if the user's target market is identified in relatively high concentrations within the general population of a geolocation, the system may optimize nonfungible token digital products or digital items that are listed for sale or auction, and that are associated with relatively matching geo-specific data, to be presented amongst the first items displayed during the shopping experience, according to programmable instructions.

The virtual auction or trading environment may or may not include nonfungible token digital product listings via an application programming interface (API) that may allow the system to interoperate with other nonfungible token virtual sales environments. The embodiment may further comprise a multichain ledger or blockchain.

The system may include an embodiment wherein the user may stock virtual shelving items or stage virtual space within a virtual design environment, with scaled virtualizations, imagery, virtual replicas, or virtual representations of physical/real-world product items, physical/real-world branding materials, or other physical/real-world materials. Tools and functionalities of the said virtual design environment may include such but not limited to graphics rendering, physics simulation, input handling, audio processing, or networking, or may include a game engine computing framework. Upon the procurement of a nonfungible token virtual item that represents physical/real-world items or space, or upon the placement of virtualizations of items from an online product repository onto the background of a virtual design environment, or upon the stocking of scaled virtualizations of shelving and product display items with scaled product item virtualizations, imagery, or replicas from an uploaded product repository of a merchant-to-consumer website associated with a user profile, within a virtual design environment; a communication protocol may then configure a bill of material including metadata, and transmit the data to a supply computer device, informing a third-party supplier to deliver the materials to the building or construction site, receiving a material delivery information, receiving an internal and external inspection information, receiving regulatory compliance information, receiving insurance information and receiving labor information, debiting a first account associated with the project and crediting a second account associated with the project, creating a live feedback channel with records or certificates representing various verifications of stages of site construction and product staging and storing the records or certificates on a distributed ledger. Metadata generated during a virtual shocking or staging experience, may be further configured into an augmented reality image overlay over real-time, real-world imagery, wherein image matching and remote sensing technologies are implemented in stocking or staging instructions generated by the metadata produced and stored on a device node during the stocking or staging experience of an interior design phase within a virtual design environment. The metadata is transmitted to a mobile device that may be configured to receive a transmission of metadata to nodal devices, and that are capable of vision-based object registration for real-time image overlay, or transmitted to devices that are capable of vision-based object registration for real-time image overlay and that are pairable with a mobile device node, the device node associated with or representing a laborer, servicer or “hired personnel.” The data overlay onto real-world imagery may be further implemented in a real-time feedback transmission that tracks progress. Progress tracking may include communication protocols for receiving remote sensing, temporal resolution, and pattern recognition data as part of the communication protocol for generating and transmitting an augmented reality display of staging and/or design instructions to a third party device according to metadata representing a building design model, or a staging design model wherein remote sensing, or temporal resolution, or pattern recognition data of a third party augmented reality display device or device node, is further configured to generate live project completion status feedback to a user node representing the purchaser of an nonfungible token digital product, and/or to a user node that represents the sender of metadata transmissions that represent items in the real-world imagery recognized by pattern recognition programming in an augmented reality display, or to a user node representing the designer of a venue or retail space within the design computing device wherein augmented reality metadata is generated during the design process. The computer readable successful procurement of commercial floorspace, or shelf space, may actuate a secondary interior and/or exterior design phase whereby metadata and/or a bill of material may be further configured and transmitted to a third-party device. Furthermore, modular unit construction metadata of a virtual design environment or building design computing system may be further inputted or transmitted to 3D-printing computer device, a robotic welding computing device, a computer numerical control (CNC) computing device, an automated painting system computing device, or a modular assembly line computing device for the automated fabrication of modular or prefabricated construction units.

The virtual design environment may further include a tool for adding augmented reality elements to the virtual background of a virtual design environment by which the system may be configured to allow for the application of geotargeted augmented reality elements according to computer readable instructions. Augmented reality elements may be applied via access to a photo archive, via API or transmission control protocol access to an NFT art trading platform, or via a text generator that may be configured to apply interactive or non-interactive images, or texts, or URLs, to live imagery captured by a mobile device node that is capable of vision-based object registration and/or capable of processing real-time image overlay metadata transmissions, wherein the transmission of real-time image overlay metadata is actuated through a programmable ticket sales system and/or spatiotemporal querying, and wherein the device node represents a “consumer” device node or a “hired personnel” or “servicer” device node.

This technology and the methods herein, may further be applied to an event planning system, a commercial event planning system, a pop-up event planning system, an event planning system, wherein commercial space or shelf space of a prospective event or at a live event are traded. This technology and methods outlined herein may also be applied to a real estate trading system. A “pop-up event” in this context, is to be understood as a location or commercial location opened temporarily to take advantage of a faddish trend or seasonal demand.

The system may further include a user interface wherein the user node of a master profile is associated with a social media profile denoted by relatively favorable data that may indicate a social influencer or relative popularity amongst an online constituency as defined by programmable parameters. This embodiment includes a virtual NFT trading environment wherein the likeness of a social influencer of a master user profile is traded as an NFT and/or as a digital product wherein said likeness may be traded as NFTs and/or digital items the form of static imagery, audiovisual content, and/or videographic content, that is assigned a hash value within a blockchain infrastructure, or within a multichain infrastructure of a virtual trading environment and/or virtual auction environment. Datasets representing an online constituency associated with a “social media influencer” user account, may be configured to represent variables in a dataset valuation model that may be implemented in a nonfungible token or digital item valuation or pricing method whereby digital products containing the said user's likeness are priced. This embodiment may further include a “social media influencer” likeness NFT and/or digital trading environment wherein a “buyer” is defined as having user profile that represents a “retailer” user associated with a target market profile and/or a merchant-to-consumer website, and wherein a seller is defined as a “social media influencer” user with a user profile that is associated with social media constituency data. The shopping experience may include and optimization mechanisms wherein social media influencer likeness digital items or NFTs are prioritized as the first items that appear during the shopping experience, according to computer readable correlations between the target market data of a said “buyer” user and the social media constituency data of a plurality of said “seller” users. This embodiment may further include a two-way communication system for direct messaging between a said “buyer” user and a said “seller” user which may or may not be a component of a talent search and recruitment technology service that provides a programmable method of commissioning “seller” users and/or “talent” users for a live appearance at a prospective event or shop. However, this embodiment further includes a digital template as part of a programmable method for creating an augmented reality ad campaign, wherein the background of the template is the interactive (or non-interactive) static imagery, or the interactive (or non-interactive) virtual rendition, or interactive (or non-interactive) satellite imagery of a prospective geophysical shop or event location, or of a geophysical location not associated with any prospective shop or event, and wherein the procured digital likeness item of a social media influencer may be superimposed onto the background generating metadata in a preview display of the augmented reality ad campaign. The said metadata is then transmitted to a plurality of remote geotargeted nodal devices that are capable of vision-based object registration for real-time image overlay, and/or to nodal devices that are pairable with devices that specialize in vision-based object registration and real-time image overlay for augmented reality experiences, wherein the device node represents a “target market” node.

The system further includes an embodiment comprising digital templates that are part of a programmable method of creating an augmented reality ad campaign, wherein the background of the template is the interactive (or non-interactive) static imagery, or the interactive or (non-interactive) virtual rendition, or the interactive (or non-interactive) satellite imagery of a prospective geophysical shop or event location, or of a geophysical location not associated with any prospective shop or event, and wherein NFT art or digital content transmitted via API or TCP/IP with a digital art or NFT auction or trading platform, or from an NFT art or digital art auction or trading platform embodiment, or digital art or content from a photo archive of a device, may be superimposed onto the background, generating metadata in a preview display of an augmented reality ad campaign. The said metadata is then transmitted to a plurality of remote geotargeted nodal devices that are capable of vision-based object registration for real-time image overlay, or to devices that are capable of vision-based object registration for real-time image overlay and/or nodal devices that are pairable with devices that specialize in vision-based object registration and real-time image overlay for augmented reality experiences, wherein the device node represents a “target market” node.

The embodiment may further include a method whereby static imagery, videographic, or audiovisual content containing a person's likeness, is applied to an augmented reality display generating metadata that is transmitted to a geotargeted node or device within a geographical location according to a communication protocol from a “buyer” node that indicates a purchaser of the nonfungible token that represents said static imagery, videographic content, or audiovisual content which contains the likeness of a person that is represented by a “social media influencer seller” node.

The system further includes an embodiment wherein predictive modeling through the programmable preliminary testing of markets, the improvement of target market profile data, the enhancement of social graph correlative analysis, and the generation of digital wallet reserves, is achieved through a programmable concept gamification method comprising a virtual reality, or virtual gaming environment. The said gaming environment is an environment for the trading of virtual items wherein the virtual items represent geophysical locations at which an augmented reality ad campaign is to be displayed by the owner (or renter/borrower) of a digital item subsequent to procurement. The players of a game represent registered users with a (retailer) user profile that is associated with a target market and/or a merchant-to-consumer website. The system is programmed to select players for a single game based on varying degrees to which a target market is shared, thereby creating a competitive atmosphere. The game currency may represent single use tokens, or may represent a cryptocurrency, or may represent fiat currency, or a combination thereof. The value of the game currency may be determined according to a dataset valuation method by which an aggregate of data extracted in regard to a relatively shared target market, or consumer price index relative to a general product category relating to business registration criteria, is a variable in mathematical logic implemented in the monetization of datasets. The digital items traded in the game may be geotagged to a geophysical location that represent the location for an augmented reality ad campaign. The trading game may be like the board game Monopoly, for example, wherein the object of the game is to buy up property spaces that are geotagged to locations having a relatively high percentage of the total population that represents a shared target market. The game may further allow for the procurement of virtual property improvements such as but not limited to virtual buildings or modular construction items that resemble a pop-up storefront. The size and game currency value of the said virtual property improvement translates to an “ad reach” or range that may determine the number of locations within a given area at which an augmented reality ad may be displayed on geotargeted nodal devices. The virtual space game dollar value may be determined according to a programmable dataset valuation mechanism; for example, if the most valuable virtual property space is geotagged to Los Angeles, California having a total population of 4.085 million people with 38% percent of the total population belonging to a target market that is relatively shared amongst the players of a given game, the game dollar price of the highest valued space could be equal to the percentage number multiplied by ten, bringing the price of the highest valued virtual property space to 380 game dollars. After the game dollar value of the highest valued virtual property space has been calculated according to programmable mathematical logic, the game dollar value of the remainder of the spaces are determined according to a relative valuation system; for example, if a virtual property space is geotagged to Boise, Idaho having a total population of 228,790 people of which 50% or 114,395 belong to a shared target market, the relative valuation mechanism would determine that the shared target market population of Boise, Idaho is 0.074% of the shared target market population in Los Angeles, California thereby multiplying the game dollar value of the highest valued virtual space (380 game dollars) times 0.074% which would bring the game dollar value of the virtual space representing Boise, Idaho to 28.12 game dollars respectively. The fiat valuation of a game dollar may also be determined via the programmable implementation of a dataset valuation system; for example, if the players' collective product categories associated with their user profiles fall into a specific or general consumer price index group such as “clothing and footwear,” the system may extract data pertaining to the GDP per capita or the average household expenditures allocated to this specific category. For example, if the average household expenditures allocated to this consumer price index group is $285.93 per year, the system may then price a single unit of game currency at $2.86 per game currency token, bringing the fiat currency value of the highest valued virtual property space to $1,086.53, and the fiat value of the virtual property space geotagged to Boise, Idaho to $80.06 respectively. The procurement of a virtual space may actuate an augmented reality ad template for the creation of augmented reality ads much like that described above. The game may further include a programmable turn-taking method by which players may or may not “land on,” “visit” or “rent” virtual spaces that are owned by other players, in this respect the shelf space or commercial space trading aspect of this system is simulated in the virtual reality/virtual gaming environment as part of concept gamification method.

The said virtual reality/virtual gaming environment generates data from the interaction of players that may aid the system in the optimization of co-sponsorship candidates and preferred shelf or commercial space bidders. Furthermore, this method may also help to generate more data that could further define a target market. There may or may not be variations of this method wherein the virtual items representing geographic locations are nonfungible tokens, or variations that included an augmented reality ad campaign builder template wherein ad content comprises digital art of an NFT auction or trading environment.

The system may further include an embodiment comprising of a cross-platform game engine and system for managing game-playing experiences, and/or an API and/or communication interface for external game engine interoperation, as well as a geotargeted augmented reality game digital marketplace wherein the method further comprises a user interface for “game developer” users or users that create augmented reality game packages that may be sold as digital items to “retailer” users as an NFT and/or as a digital item that represents augmented reality game content that may be geotargeted to an event location as part of a local blockchain (or directed acyclic graph also known as a “DAG” block). The method further comprising a cloud-based machine-readable data storage medium for generating interactive augmented reality games updating games, adding to game data, as well as a cloud-based machine-readable data storage medium for device nodes and software products that are capable of vision-based object registration for real-time image overlay and/or device nodes that are pairable with software products that specialized in real-time image overlay for augmented reality experiences, wherein the storage media may include a distributed ledger in the form of a DAG block or spatiotemporal blockchain. Other variations of this mechanism may include a method of data storage across a range of mobile device nodes a that are part of a spatiotemporal network. In this embodiment the “game developer” user interface may include a game application layer, an engine module, a system layer, a compiler, a datastore of geographic imagery either mined or imported via an API with datastores such as but not limited to Google Maps, a datastore of a 3D drawing and construction module for compiling in an augmented reality environment. The method may further include a direct messaging system or recruitment service technology by which a game developer user profile may be configured to receive metadata and customized game request information from a “retailer” user profile, thereby providing geophysical information relative to a prospective event or storefront location that may be implemented in the programmable augmented reality game development process as a template or computing framework for the development of augmented reality game interaction and real-world integration rules.

This embodiment further includes a user interface for “consumer users” by which a location-based parallel reality gaming experience is actuated by spatiotemporal querying as part of a consensus protocol, and/or via online admissions or ticket purchasing as part of a proof-of-work protocol wherein the parallel reality game access point or plurality of access points corresponds to a real-world pop-up event or pop-up storefront(s) location(s). Game features can be linked with activities in a real-world environment such as commercial activity and/or data collection activities within the real-world environment. Augmented reality elements of the game may be linked physical markers or elements in a real-world environment such as buildings, trees, signage, temporary construction items, murals, and landmarks, whereby the player is required to travel a geographical distance within a parameter to engage different parallel reality gaming elements. Game tokens may also be used in the purchase of real-world products or services being offered for sale at a participating pop-up event or at a participating pop-up retail storefront location, adding an incentive for game play that may result in the winning of game tokens as part of a location-based peer-to-peer network and player interaction protocol. Game tokens may represent a digital currency or a fait currency that may be exchanged on a local blockchain (DAG block), or on a location-based temporal blockchain wherein data is stored on player nodes, or digital wallets, whereby game tokens may be saved for use at other participating pop-up events or pop-up storefront locations.

The parallel reality gaming system further includes a live data-mining feedback channel wherein the method includes obtaining environmental data of a real-world environment from the camera of a plurality of player-nodes or a devices pairable to a player-node and self-correcting datasets that lack geophysical detail according to a spatiotemporal and temporal comparative analysis of images within a datastore by which game content translation may be improved in the hybridization of data extractions, thereby generating and storing said data extractions on a game server and/or on a cloud server of the said game engine whereby the game development experience is enhanced. For example, such geophysical details obtained may include shadow depths of an object at a particular time of day and year that may help to apply corresponding pixel depth to an augmented reality item according to the spatio-temporality of the viewer, creating a hyperrealism component to the parallel reality experience. Live-data extractions may further allow for live game content updates by which a live gaming experience is enhanced. For example, if a datastore of a location does not include temporary construction items of a pop-up event or storefront that impede augmented reality game content image overlays, the obstruction may be self-corrected via an image recognition algorithm that may augment the game experience according to updates in geological features that may not have been present in geographic environmental datastores at the time that the data was extracted.

The system may further include an archiving system that includes a datastore for shipping containers and modular units that have been procured by users, and further includes the integration of container tracking systems or container management systems that use a combination of methods such as but not limited to GPS, RFID (Radio-Frequency Identification) and IoT (Internet of Things) sensors, to monitor the location and status of individual shipping containers or modified units, and store data about each container, such as its identification number, weight, and destination, and is capable of tracking its movement throughout the shipping process. These integrations may further include the temporal querying of onboard technology or cellular devices that are relative to the shipment of said containers. Each (retailer) user profile that is eligible for container procurement or container use, may include container archives.

The system may further include an archiving system that includes a repository or datastore for user real estate property procurements that are associated with a (retailer) user profile, whereby computer readable instructions may allow for the trading of user procured real estate as part of real estate shopping environment whereby the said real estate procurements may be traded as NFTs.

The system may further include a programmable method for routing mobile pop-up shop truck stops wherein an API or programmable communication protocols with event planning and/or ticketing websites populate an interactive GIS map with prospective events that may be selected as route stops according to computer readable instructions. The background of the GIS map may include data layers that indicate locations of favorable demography or target market data, wherein map indicators that indicate upcoming events is an interactive foreground layer. Other map indicators that indicate a dispatch center for caseload pick-up, may be added to the foreground layer as part of a method for routing a dynamic mobile pop-up shop route that allows for the restocking of inventory between route stops. This method may further include a communication protocol for fleet management wherein the method includes the temporal querying of autonomous vehicle onboard technology, or the temporal querying of cellular technology. This embodiment may further include a location-based recruitment service that may be actuated upon the selection of a stop on the route, whereby the computer readable successful completion of a hiring process at each stop on the route helps complete one of the task requirements to activate the route, other tasks may include such but not limited to the computer readable successful scheduling of wholesale order drop shipments to one or more caseload pick-up locations on the route, the successful scheduling or hiring of truck drivers, the successful procurement of an autonomous vehicle, and/or the successful scheduling of participation at a prospective event which may or may not include pop-up shops or events scheduled through this system as well as events scheduled via other programs.

This system may further include a method by which the emplacement or extractions of modular units or modified shipping container units within a modular cell tower frame are scheduled via modular cell space auction cycles. This method is much like the aforementioned commercial floorspace auction method, wherein the difference include auctions that are largely autonomous, being operated by a deep learning algorithm that determines auction entry eligibility according to factors such as but not limited to, registered business and/or product category relative to a patronage flow floorplan model, product/service pricing relative to locational GDP per capita or consumer price index data extractions, shipping container or modular unit archives, shipping container or modular unit procurement, shipping container or modular unit design mockup metadata, modular unit or modified shipping container feature requirements, modular unit or modified shipping container sizing requirements, and modular unit shipment and arrival estimates. Furthermore, the auction lots are modular cells within a tower fame that limit auction entry eligibility to a preferred user as determined by deep learning algorithms, or by criterial inputs of a designated auction manager that represents the user registered under a master user profile or registered under a joint-user profile with limited or full access to the joint-user account. Auction cycle programming may include a communication protocol with a robotic mounted crane computing system that may be configured to schedule the extractions and emplacements of modular units or modified shipping containers according to auction cycle data, as well as fleet management system data whereby the shipments of shipping containers or modular units are scheduled and managed.

The system may further include a machine learning natural language processing conversational agent that may be integrated with system embodiments including such but not limited to robotics systems, fleet management systems, truck routing systems, virtual design environments, a virtual real estate shopping environment, parallel reality environments, virtual sales and auction space environments, shipping container archiving systems, and SMS text messaging systems, whereby the conversational agent programmed to process natural language inputs or natural language speech, from an authorized user and preform functions throughout system integrations as a programmable consumer service assistant. Furthermore, the conversational agent may be integrated with a modular cell sensor network in the programmable management of the emplacement or extractions of modular units, as a reporting system that is capable of reporting problems such as but not limited to system jams, extraction or emplacement failures, shipment delays and progress. The conversational agent may also be programmed to remedy system issues by processing commands from natural language and/or natural language speech and preforming tasks.

### INCORPORATION BY REFERENCE

All publication and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1A. is a depiction of a virtual design space with a scaled virtualization of a real-world shelving item presented with the option of selling shelf space as an NFT, and with the option of stocking the virtual shelving item with scaled virtualizations of real-world products from the user's product repository, as a means of drafting a wholesale drop-shipment order.

FIG. 1B is a depiction of the said virtual design space with a scaled virtualization of a real-world shelving item presented with the option of selling shelf space as an NFT, and with the option of stocking the virtual shelving item with scaled virtualizations of real-world products from the user's product repository, as a means of drafting a wholesale drop-shipment order, wherein the option to mint a shelf space NFT has been selected.

FIG. 1C is a depiction of the said virtual design space with a scaled virtualization of a real-world shelving item presented with the option of selling shelf space as an NFT, and with the option of stocking the virtual shelving item with scaled virtualizations of real-world products from the user's product repository, as a means of drafting a wholesale drop-shipment order, wherein the option to stock the shelving item has been selected.

FIG. 1D is a depiction of the said virtual design space with a scaled virtualization of a real-world shelving item presented with the option of selling shelf space as an NFT, and with the option of stocking the virtual shelving item with scaled virtualizations of real-world products from the user's product repository, as a means of drafting a wholesale drop-shipment order, wherein the option to stock the shelving item has been selected, and wherein the virtualization of the product selections have appeared on a shelf.

FIG. 2A is a depiction of a device that is capable of vision-based object registration for real-time image overlay, wherein the device is displaying parallel reality imagery from a metadata transmission generated within a virtual design environment, as part of a programmable image matching inventory stocking guidance and live progress feedback system.

FIG. 3A is a depiction of an auction environment composing an interactive GIS heat map with data layers that indicate favorable datasets as areal overlays on the map, as well as map indicator icons that indicate locations relative to interactive map key criterial selection items.

FIG. 4A is a depiction of an auction environment composing an interactive GIS heat map with data layers that indicate favorable datasets as areal overlays on the map, as well as map indicator icons that indicate locations relative to interactive map key criterial selection items, wherein a map icon has been selected, thereby actuating a shelf space auction shopping experience.

FIG. 4B is a depiction of an auction environment composing an interactive GIS heat map with data layers that indicate favorable datasets as areal overlays on the map, as well as map indicator icons that indicate locations relative to interactive map key criterial selection items, wherein a map icon has been selected, actuating a shelf space auction shopping experience, and wherein the shopper's product repository is displayed.

FIG. 5A is a depiction of an auction environment composing an interactive GIS heat map with data layers that indicate favorable datasets as areal overlays on the map, as well as map indicator icons that indicate locations relative to interactive map key criterial selection items, wherein a map icon has been selected, thereby actuating a shelf space auction shopping experience and wherein the shopper is presented with brand positioning and floor layout patronage flow data relative to the shelving item.

FIG. 6A is a depiction of a virtual design environment wherein a sector of virtual floorspace has been indicated as a floorspace NFT for sale.

FIG. 7A is a depiction of an auction environment composing an interactive GIS heat map with data layers that indicate favorable datasets as areal overlays on the map, as well as map indicator icons that indicate locations relative to interactive map key criterial selection items, wherein a map icon has been selected, actuating a floorspace auction shopping experience.

FIG. 8A is a depiction of a virtual design environment, wherein the selection of a “hire personnel” button as caused a “personnel” icon to appear, further presenting with job recruitment service technology options.

FIG. 9A is a depiction of an “employee” or “job seeker” user interface wherein the user is presented with programmable options to sell their “skillset” criteria as NFTs.

FIG. 10A is an illustration of a “social media influencer” user interface, wherein a phase in this embodiment is depicted showing live campaign and follower constituency analytics.

FIG. 11A is an illustration of another phase in the “social media influencer” user interface that is depicted showing ad content builder instructions.

FIG. 12A is an illustration of an embodiment within the “retailer” user interface wherein the embodiment is an influencer likeness digital item trading platform.

FIG. 13A is an illustration of an embodiment within the “retailer” user interface wherein an augmented reality ad campaign geotargeting mechanism is depicted as part of a gravity-based predictive model and heat map.

FIG. 13B is an illustration of an embodiment within the “retailer” user interface wherein an augmented reality ad campaign geotargeting mechanism is depicted as part of a gravity-based predictive model and heat map, and where in a street view of various locations that are eligible for augmented reality ad content display is presented.

FIG. 14A is a diagram depicting an example of the conversions of metadata into cryptographic hash functions within a distributed ledger of a NFT trading or auction environment.

FIG. 15A is a depiction of a concept gamification method and gaming environment for the trade for augmented realty ad space, as part of the “retailer” user interface.

FIG. 16A is a depiction of a modular tower frame composing a module sensor system and a robotic mounted crane, for the emplacement and extraction of modular construction units or modified shipping containers that are transported to and from the site according to floorspace auction cycles.

FIG. 16B is a depiction of various modular tower frame configurations that may occur with auction cycles.

### DETAILED DESCRIPTION OF DRAWINGS

It should be appreciated that these drawings are presented for illustrative purposes only and are not limited of the aspects contained herein or the claims presented herein in any way. One or more of the arrangements may be widely applicable to numerous aspects as may be readily apparent from the disclosure. In general, arrangement are described in sufficient detail to enable those skilled in the art to practice one or more of the aspects and it should be appreciated that other arrangements may be utilized and that structural, logical, software, programming, electrical and other changes may be made without departing from the scope of the particular aspects. It should also be appreciated that the features described herein are not limited to usage in the one or more particular aspects or figures with reference to which they are described. The present disclosure is neither a literal description of all arrangements of one or more of the aspects that must be presented in all arrangements therefore the drawing and headings of sections provided in this patent application and the title of the patent application are for convenience only, and are not to be taken as limiting the disclosure in any way.

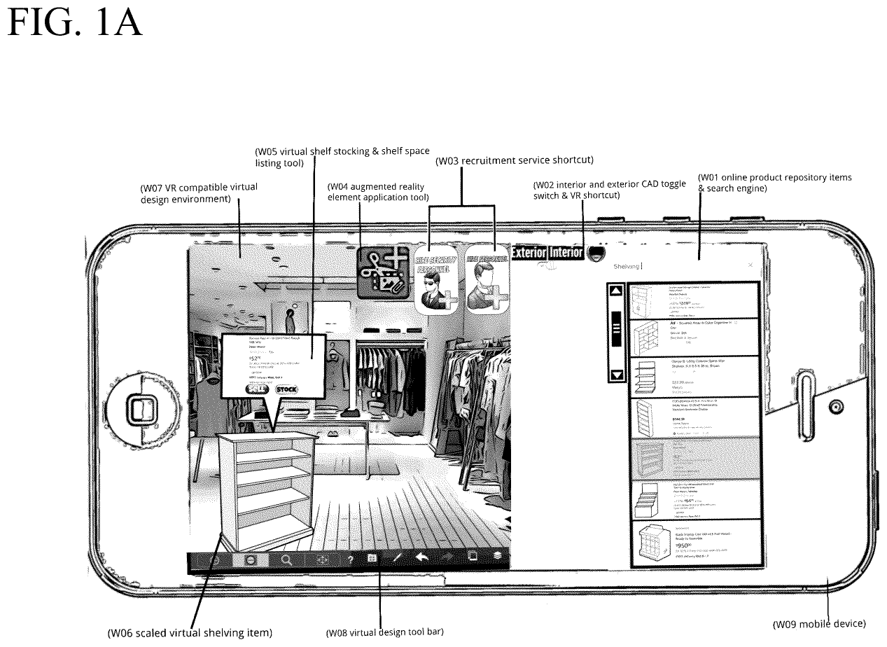

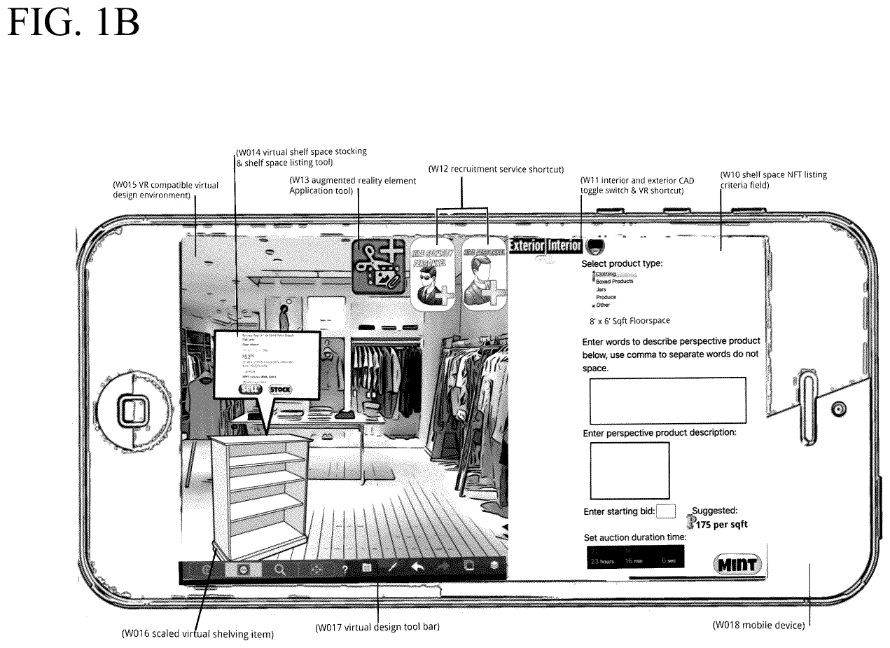

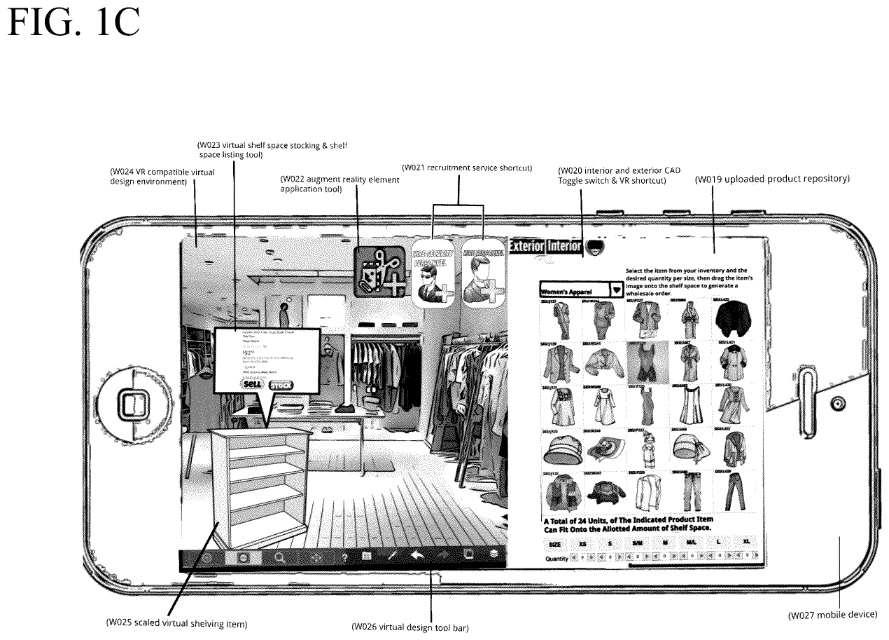

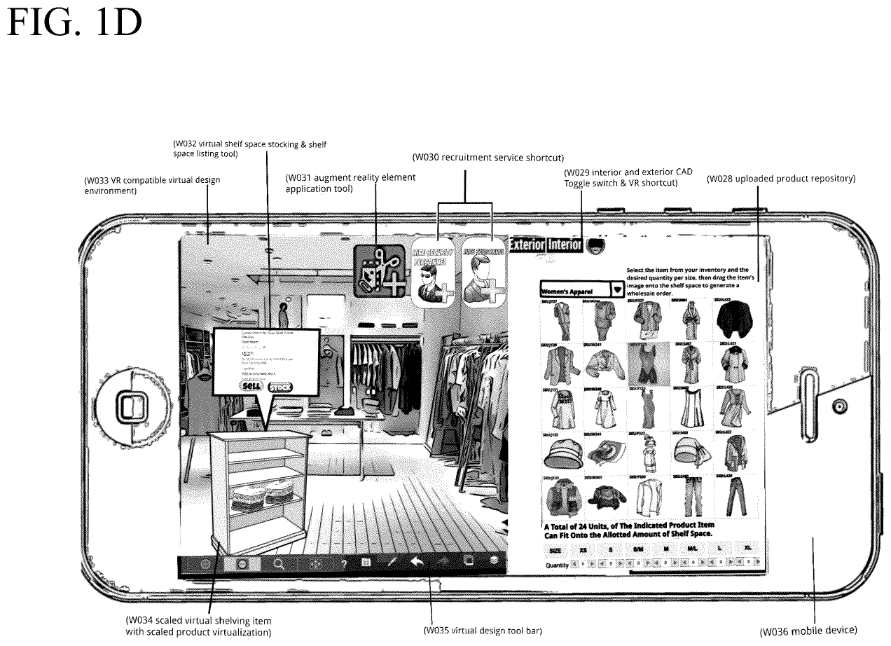

Wireframe image FIG. 1A depicts the interior design phase of a virtual reality technology device compatible with an interactive virtual design environment (W02 & W07), wherein the system is configured to apply a scaled virtual rendition of a real-world shelving item (W06) onto an indicated virtual areal sector of the interactive background, that has been selected from the online repository of shelving item products depicted in image item W01, according to computer readable instructions. The online repository may be provided via an application programming interface (API) or a communication protocol that includes one or more online sales environments, or may be provided by a sales environment generated in an embodiment that may be configured in a way that would permit users to buy or sell products from other users according computer readable instructions, or may be provided by a combination thereof. Also depicted in wireframe image 1A, is a virtual item tab (W05) that is specific to display items such as the said shelving item, wherein the shelving item's price, measurements, sales website link and other product information is displayed along with a virtual shelf space stocking and listing tools. The virtual shelf stocking and listing tools provide the user with the option to either list the shelf space for sale (or mint a shelf space NFT), or stock the shelf space with scaled virtual renditions of products from a product repository that was generated during the business registration process of linking a merchant-to-consumer website. Image item W04 illustrates a tool by which the system may be configured to allow for the application of augmented reality elements according to computer readable instructions. Augmented reality elements may be applied to the virtual background of a virtual design environment via access to a photo archive, or via an API or transmission control protocol access to an NFT art trading platform, or via a text generator that may be configured to apply interactive or non-interactive images or texts or URLs to live imagery captured by a mobile device that is capable of receiving and processing real-time image overlay metadata transmissions, or to a mobile device that is pairable with devices that specialize in real-time image overlay processing for augmented reality or parallel reality experiences wherein the transmission of real-time image overlay metadata is actuated through a programmable ticket sales system and/or spatiotemporal querying.

Wireframe image FIG. 1B depicts the tool panel that appears after the system is configured to indicate the “sell” option depicted in item W05 of wireframe image FIG. 1A, or in item W014 of wireframe image FIG. 1B. The tool panel depicted in image item W10, illustrates criteria field options that either defines restrictions for the restricted access to a private online auction space, or provides bid weighting criteria that would help to encourage the auction entry of specified users through computer readable optimization techniques. The bid weighting mechanism is not depicted in the wireframe image, however, the method comprises a dataset valuation protocol wherein the value of a currency is artificially inflated or deflated by a percentage that represents the degree to which the user profile of a bidder represents preferred datasets that are indicated by criteria items according to computer readable instructions. For example, if computer readable data representing a user profile matches the entered criteria or default criteria to a degree of 50% or more, the value of a single monetary unit may be increased by 50%. In other words, if the currency used in the auction is the U.S. dollar, a dollar bid by the user with the profile with a 50% match in preferred data sets is worth one dollar and fifty cents. A user with only a 20% match in preferred data sets would need to outbid the user with a 50% match by a rate of thirty cents per dollar bid by the most preferred user, in order to successfully procure the shelf space listing for product participation at the upcoming event as defined by computer readable instructions. The shelf space listing thereby represents a non-fungible token (NFT) where in a dataset valuation protocol helps to determine the value of shelf space according to datasets such as but not limited to, location based consumer price index data, gross domestic product per capita data, consumer behavior data relative to specific brands or products, the user demand of shelf space relative to a specific location or to a specific seller based upon data from previous shelf space sales, the average return on investment (ROI) generated in the purchase of shelf space relative to a specific location or seller, population density of the location wherein the prospective event for which self-space is listed is to take place, the percentage of the total population that represents a target market, footfall data, topography data, social media data, online consumer behavior data, multi-cloud platform data, data extractions from API communication protocols, and other live data extractions.

Wireframe image FIG. 1C depicts a variation of wireframe images FIG. 1A and FIG. 1, wherein the “stock” button depicted in image item W032 has been indicated. The indication of the “stock” button has allowed for the generation of the shelf stocking tool panel illustrated in image item W028, wherein the product items of the user's product repository appears. The shelf stocking tools include product sizing and quality criteria fields, the use of these tools help to generate a wholesale drop shipment order.

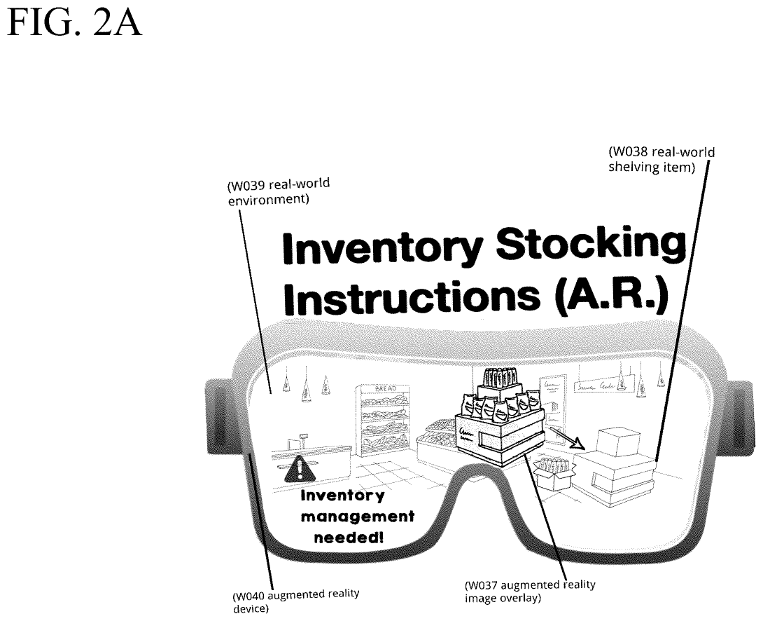

Wireframe image FIG. 1D is a variation of wireframe images FIG. 1A, FIG. 1B, and FIG. 1C wherein image item W034 illustrates a virtual rendition of uploaded product items selected from the user profile product repository, placed on the shelving item, and scaled according to quality and sizing criteria fields illustrated in image item W028 and according to computer readable instructions. The scaling of virtual product renditions is part of a method that quantifies space available for shelf-space listing or space for the addition of more products from the user product repository. Furthermore, virtual staging and stocking of products is a method of generating transmissible metadata that can be displayed on a device that is capable of real-time object registration that enables an image to be overlaid consistently onto real-world objects, allowing for an augmented reality rendition of inventory management instructions and metadata as exemplified in image FIG. 2A.

FIG. 2A depicts an augmented reality device that is capable of receiving and processing said metadata transmissions that were generated within the virtual design environment. The augmented reality device capable of vision-based object registration for real-time image overlay may represent a “servicer” user device node or may be pairable with a “servicer” user node whereby the user is identified or registered as hired personnel according to computer readable instructions. Image item W037 depicts a real-time image overlay of a virtual rendition of a real-world shelving item stocked with scaled virtual renditions of real-world product items. The real-time image recognition and image tracking algorithm has detected the shelving item and has calculated an error in product item display according to the processing of metadata transmissions received from the virtual design environment such as the one previously depicted in wireframe images FIG. 1A, FIG. 1B, FIG. 1C, and FIG. 1D.

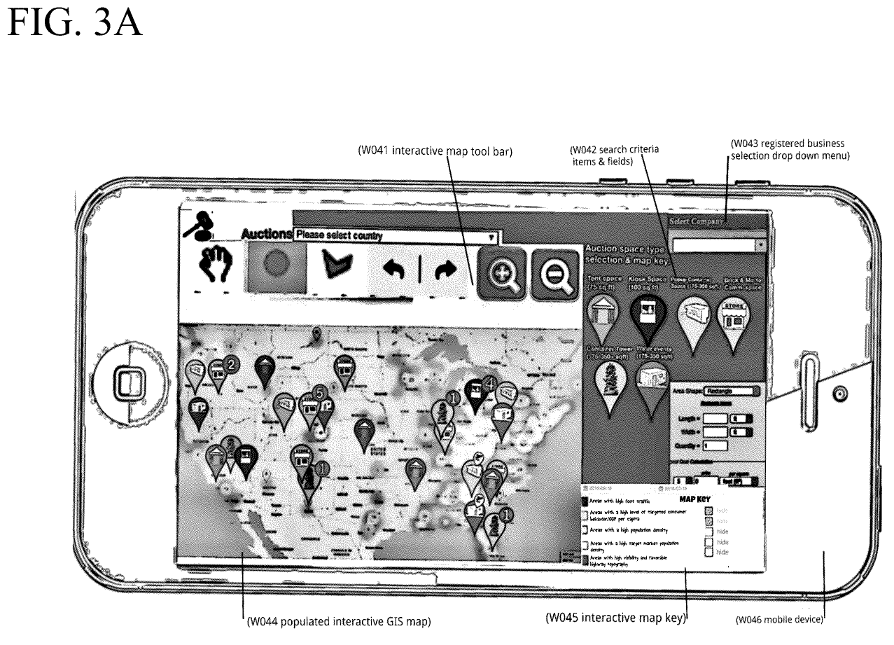

Wireframe image FIG. 3A illustrates phase one of the online auction shopping environment wherein the computer readable selection of a registered business associated with the user profile, during the registration process, along with other criteria item selections and criterial inputs, generates data overlays and location indicators on an interactive geographic information system (GIS) sitemap. Data overlay layer one is a heatmap (W044) generated according to computer readable instructions generated by an interactive map key exemplified in image item W045; data overlay layer two is the location indicators that serve as online auction space shortcuts (W044) that populate the map according to criteria item selections or computer readable configurations and criterial inputs such as those exemplified in image item W042.

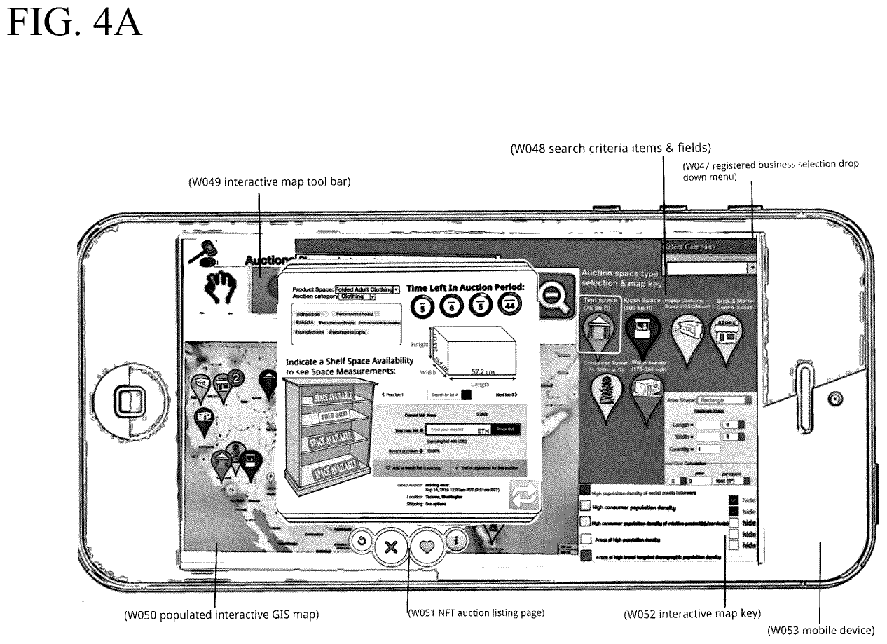

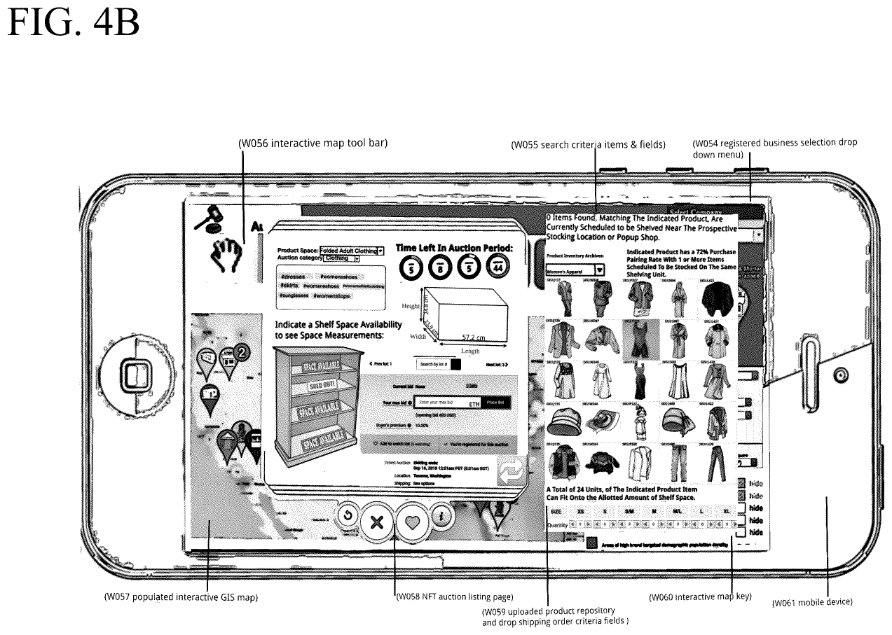

Wireframe image FIG. 4A is a variation of wireframe image FIG. 3A wherein the computer readable selection of an interactive location indicator actuates the online auction shopping process. Image item W051 illustrates and NFT auction page wherein the NFT is a virtual rendition of shelf-space that represents the shelf-space available on a real-world shelving item to be placed at a prospective real-world event. Image item W051 further illustrates shelf space dimensions information, product category criteria information, an indicator of time left in the shelf space auction, and criteria entry fields for the input of a bid amount when the accepted currency is a cryptocurrency.

Wireframe image FIG. 4B is a variation of wireframe image FIG. 4A, wherein the product repository associated with the selected registered business, is displayed as illustrated by image item W055. This may occur when the system is configured to generate a scaled virtual rendition of products that are placed onto the virtual shelving item as seen in image item W034 of wireframe image 1D, as a means of actuating the wholesale order/drop shipment process that is completed upon shelf space procurement according to computer readable instructions.

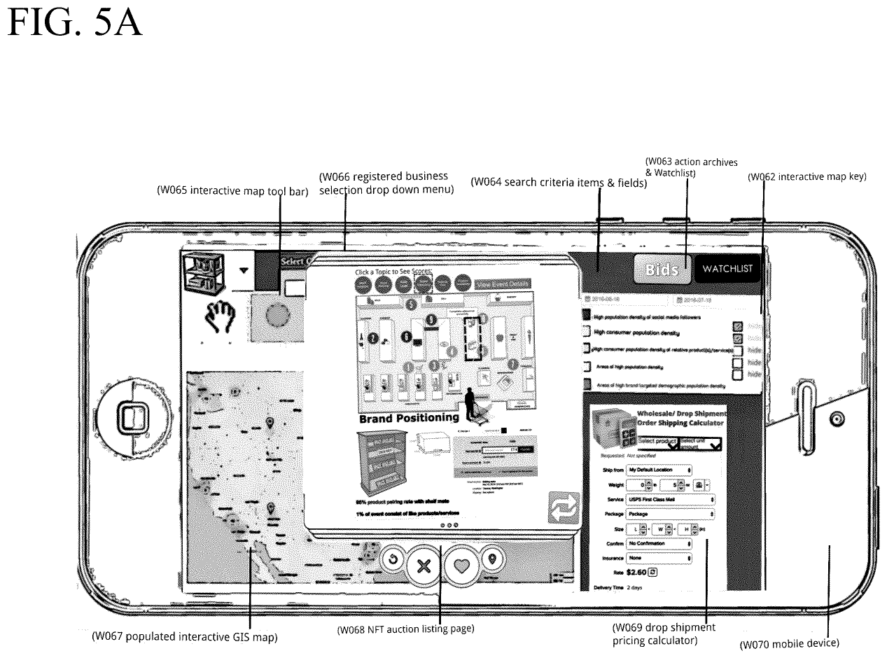

Wireframe image FIG. 5A is a variation of wireframe images FIG. 4A and FIG. 4B, wherein the auction shopping page is configured to simulate a display of the back side of a listing page (W068) according to computer readable instructions. Image item W068 illustrates a method by which the user's products are rated in a comparative analysis that would indicate a product pairing rate with adjacent items to be placed on or near the shelving item that is listed as having available space. In this context, a product pairing rate is to be understood as a consumer behavioral data extraction that measures the rate at which certain products and/or services are purchased simultaneously, or as a consumer behavioral data extraction that detects a consumer purchasing pattern between two or more products and/or services. The comparative analysis further displays information revealing the degree of sameness between the user's (auction shopper and bidder) product repository and the products that are to be offered at the prospective event. Image item (W068) further depicts a range of prospective event data analytics display selection options, as well as a “view event details” shortcut button that may be configured to display a written, or configured to actuate a virtual reality experience and display of metadata generated during the design phase, or an informational display that may further include audiovisual, or an audio overview of event information such as but not limited to themes, concepts, dates of duration, updates, etc. Image item W063 illustrates a shortcut that may be configured to display archived bids and auctions of interest.

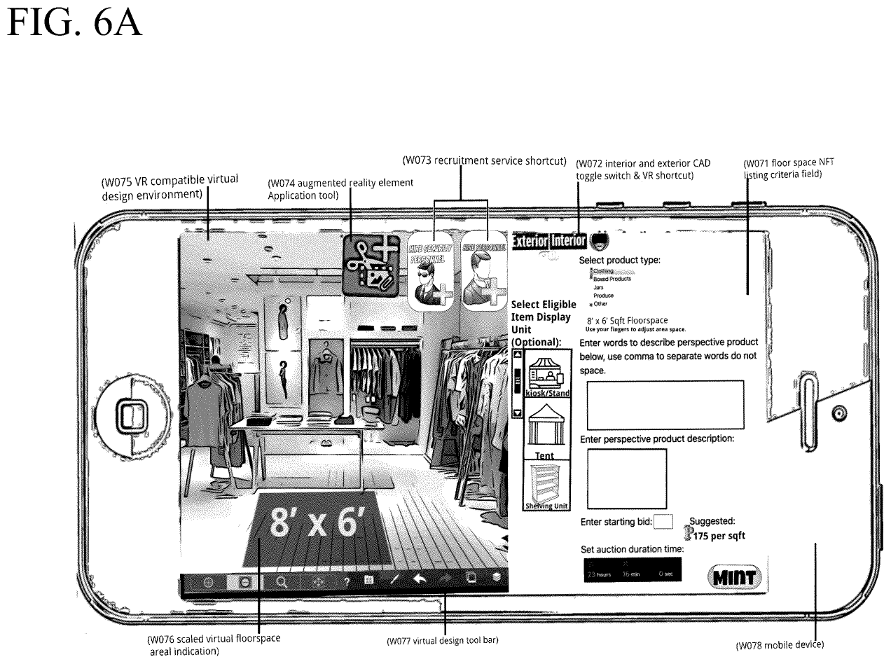

Wireframe image FIG. 6A is a variation of wireframe images FIG. 1A, FIG. 1B, FIG. 1C, and FIG. 1D, wherein the illustration depicts a method by which the configuration of tools illustrated in image item W077 actuates the indication of a floorspace sector (W076) as a floorspace availability NFT to be listed for sale in an online auction environment, according to computer readable instructions. The wireframe image further comprises a tool panel (W071) which includes a scrollable list of product display items that may be eligible for placement within the indicated floorspace sector, according to scaled dimensions. For example, eligible product display items may include an indoor kiosk, a commercial tent, or a shelving unit. The computer readable selection of a shelving unit as the preferred product display item is not tantamount to the sale of shelving item sectors as in the aforementioned shelf space trading method but would instead limit the use of floorspace to a shelving unit as part of auction entry criteria. The computer readable selection of floorspace product display criteria may actuate a product display item shopping experience involving the user profile that represents the bidding party, subsequent to the computer readable procurement of the floorspace listing, wherein the relative product display items are preselected or approved by default programming or via computer readable configurations of the user account that represents the digital floorspace NFT seller.

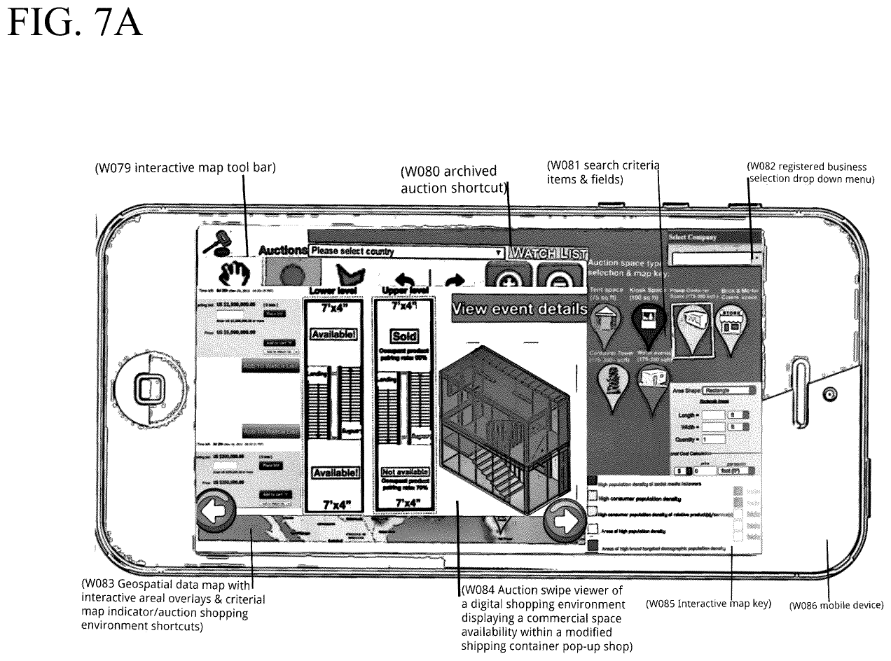

Wireframe image FIG. 7A is a variation of wireframe images FIG. 3A, wherein the image displays a floorspace auction environment. Image item W081 is an illustration of a tool panel comprising auction search criteria items and criteria entry fields. The computer readable indication of the modified shipping container floorspace selection option has actuated a shopping experience for modified shipping container floorspace NFT listings (W084) that represent real-world modified shipping container floorspace availabilities within a geographic location, displayed according to computer readable instructions.

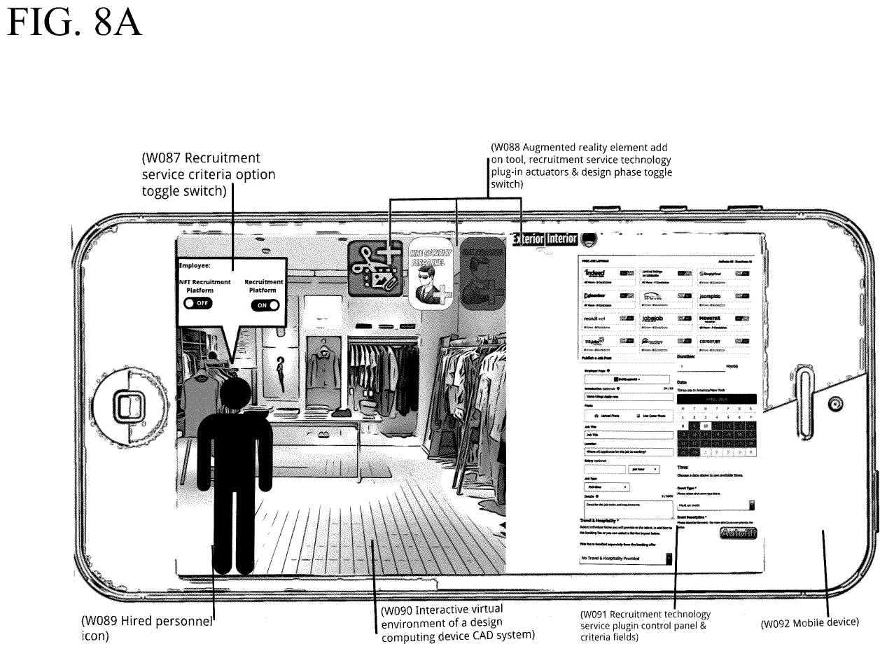

Wireframe image FIG. 8A is a variation of wireframe images FIG. 6A, FIG. 1D, FIG. 1C, FIG. 1B, and FIG. 1A, wherein the computer readable configuration of tools illustrated in image item W088 actuate the display of an API recruitment service plugin control panel, and the display of “hired personnel” icon (W089). Image item W087 illustrates a toggle switch the configuration of which, indicating the type of geotargeting job recruitment service technology that is to be implemented in the staffing process, according to computer readable instructions. The computer readable indication of the “recruitment platform,” may result in the display of multiple toggle switches in the control panel illustrated in image item W091 wherein each toggle switch is associated with a specific online recruiting service technology. Also displayed in the resulting tool panel exemplified by image item W091, are criteria fields and criteria selection items, the configuration of which may result in the optimization of search results. The computer readable configuration of the “NFT Recruitment platform” toggle switch illustrated in image item W087, may actuate an NFT virtual shopping experience wherein NFT items sold represent the hire of personnel. There may or may not be a surveillance-based consensus protocol that may include technologies such as but not limited to temporal querying, audio-visual live feedback channels, spatiotemporal querying, live feedback channels, smart contracts, escrow payment technology, smart wallet technology, image recognition/live imagery feedback channels, or geospatial intelligence technologies.

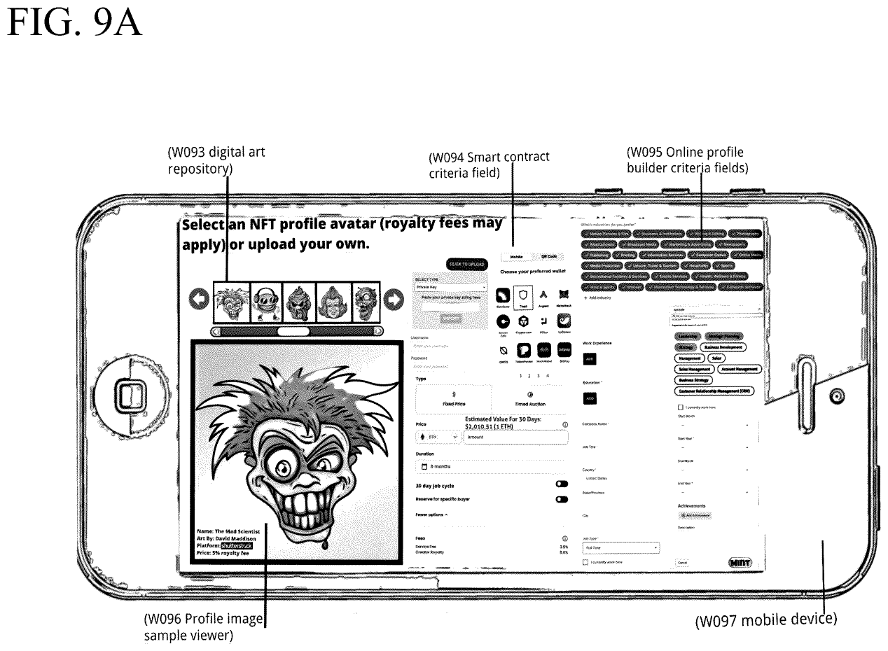

Wireframe image FIG. 9A illustrates the user interface for a job seeker as part of the multi-user interface infrastructure of the location based “NFT Recruitment Platform” technology mentioned in wireframe image FIG. 8A, image item W087. This user interface comprises a smart contract criteria field for the input of NFT pricing criteria. The embodiment further comprises criteria fields and items that outline skills, job experience and other online resume criteria. Image item W093 depicts a repository of NFT image items that would also serve as the user profile image (W096). These images may be imported from NFT sales platforms, or digital art sales platforms, or may be provided via deep learning combinatorics algorithms that create composite images from online images, or may be provided by a combination thereof.

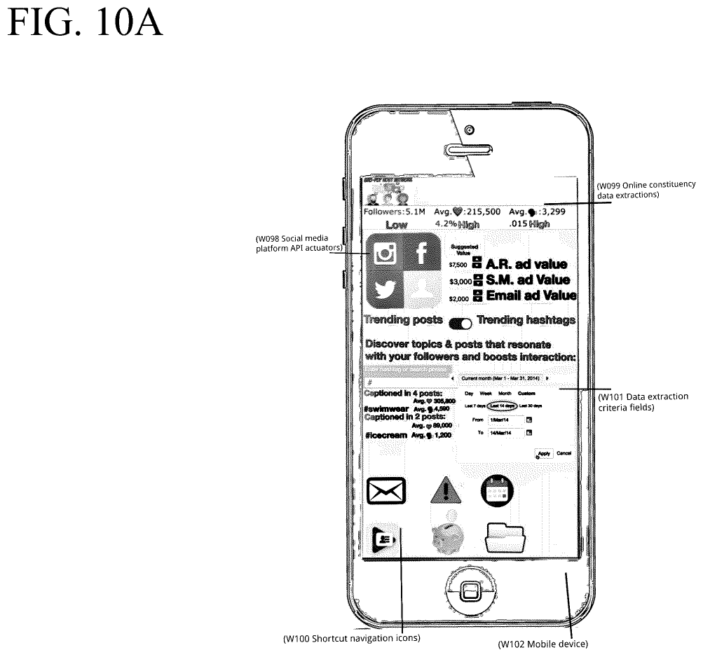

Wireframe image FIG. 10A illustrates an example of phase 1 in the “social media influencer” user interface wherein the interface comprises online constituency data extractions (W099) that are further implemented in the dataset valuation pricing model of “influencer likeness” digital item NFTs. Image item W098 illustrates social media selection options that determine which platform the online constituency data is extracted from according to computer readable instructions. Social media influencer likeness digital NFT items include items displayed in augmented reality content, social media ad content, email ad content, and SMS messaging ad content which is priced according to content display type via the aforementioned data valuation method. This phase of the social media influencer user interface, further comprises user behavior data and campaign analytics criteria fields as well as shortcut navigation icons (W100) to other embodiments in the social media influencer user interface such as but not limited to a private messaging environment, a calendar for the scheduling of live hosted events, a contact archive, online banking or crypto wallet, as well as a folder archive for social media influencer likeness digital items image uploads.

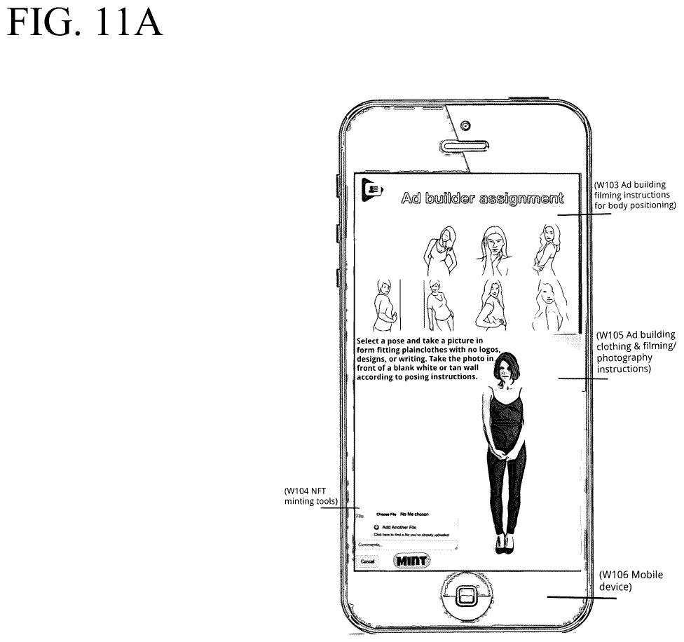

Wireframe image FIG. 11A illustrates and example of phase 2 in the “social media influencer” user interface wherein instructions for creating and uploading influencer likeness digital item NFTs that are eligible for sale as defined by computer readable instructions.

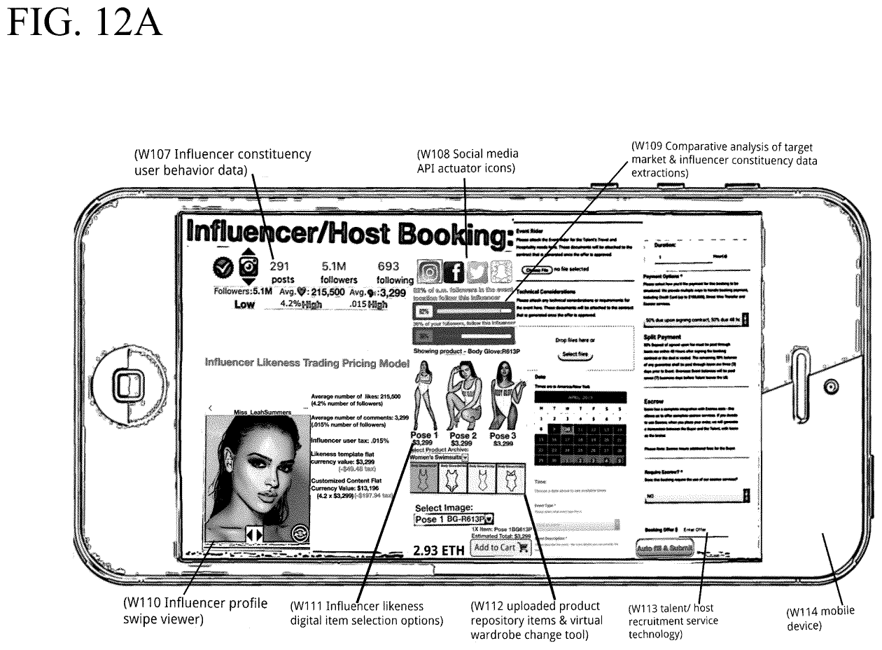

Wireframe FIG. 12A illustrates an example of a “retailer” user interface of the social media influencer talent search and NFT digital shopping environment wherein the embodiment comprises a social media platform API actuator (W108) the computer readable configuration of which actuates the optimization of candidate profiles. The embodiment further comprising a comparative analysis of data representing a target market and data representing the online constituency associated with the currently displayed social media influencer profile (W109). The embodiment further includes social media influencer constituency user behavior data (W107) and the subsequent influencer likeness digital item NFT pricing model. Also depicted are interactive social media influencer likeness digital item NFT products (W111), as well as the retailer user product repository item uploads as part of a virtual wardrobe change or ad design template tool (W112). Also illustrated is the live hosting talent recruitment service technology criteria fields and criteria items (W113) that may be utilized independent of the influencer likeness digital item NFT trading platform according to computer readable instructions. Also included is the social media influencer profile swipe shopper (W110) whereby various social media influencer profiles are displayed and by which relative social media constituency user behavioral data, comparative data analytics and social media influencer likeness digital NFT products are changed according to the profile displayed as defined by computer readable instructions.

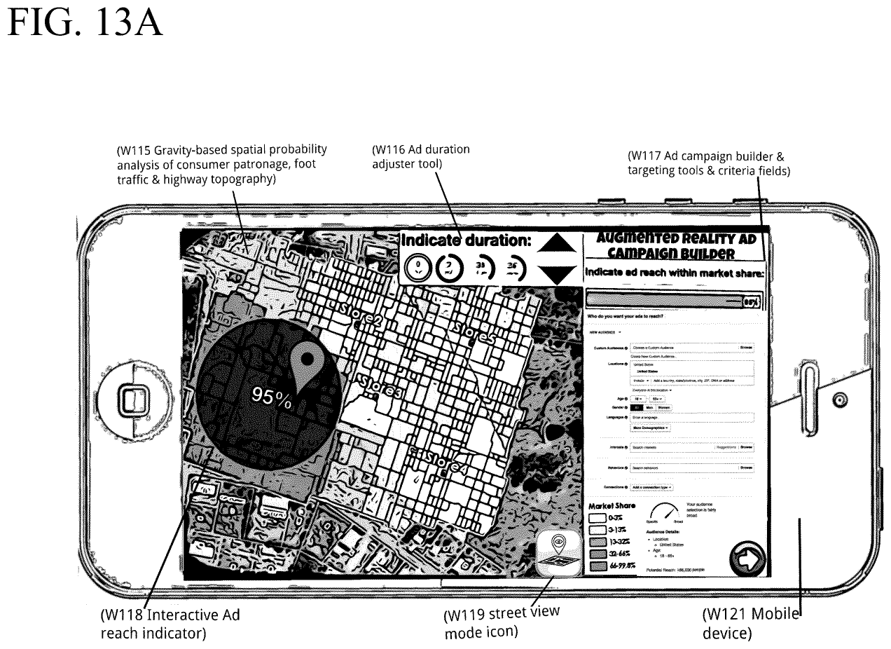

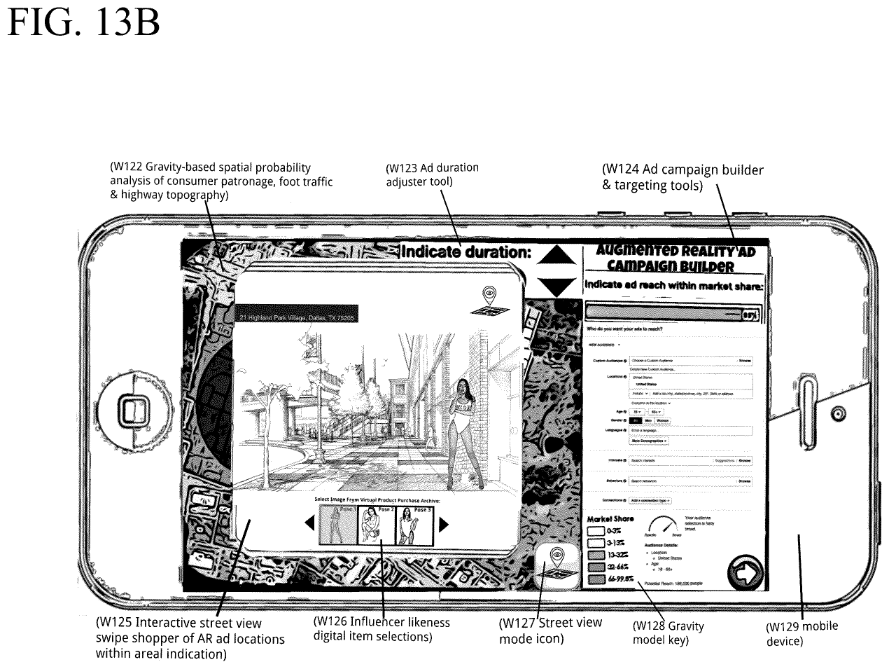

Wireframe image FIG. 13A which illustrates a method of geotargeting augmented reality ad campaigns wherein a gravity-based spatial probability analysis of consumer patronage, foot traffic and highway topography data is represented by an interactive heat map as illustrated in image item W115. The heat map is associated with percentage-based market share values illustrated in the market share map key portion of the ad campaign builder targeting tools and criteria fields panel of image item W117. Image item W118 is an illustration of an ad reach adjuster whereby an areal sector of the spatial dataset is indicated as the geotargeted range in which an ad campaign can reach. Image item W117 illustrates an example of a control panel of criteria fields and items that can be configured to further target user nodes within the geotargeted area with data outputs that relatively match a target market profile. The wireframe image further illustrates an ad duration adjuster tool (W116) whereby ad campaign duration is determined according to computer readable instructions.

Wireframe image FIG. 13B is a variation of wireframe image FIG. 13A wherein the “street view mode icon” button of image item W119 and W127 is indicated according to computer readable instructions, actuating an interactive street view swipe shopping (W125) experience of locations within the areal indication (W118-13A) that are eligible for augmented reality ad content placement. In this example, the ad campaign includes influencer likeness digital item NFT products as illustrated in image item W111 of wireframe image 12A, wherein an influencer likeness digital NFT item repository appears at the bottom of the interactive street view swipe shopper of augmented reality ad locations. The street view of the location options are configured into an interactive background onto which the influencer likeness digital items are placed as an overlay according to computer readable instructions, thereby actuating the transmission of metadata to targeted nodal devices that are capable of vision-based object registration for real-time image overlay, or to devices that are capable of vision-based object registration for real-time image overlay and that are pairable with a targeted nodal device.

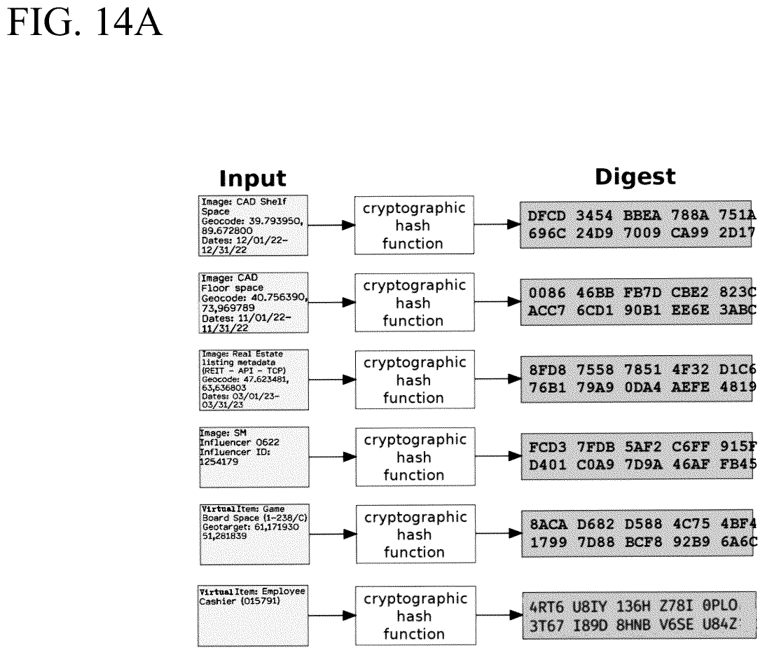

FIG. 14A is a depiction of a cryptographic hash function which may represent metadata such as digital items, physical space, real estate, virtual game items, social media influencer digital likeness items, and hired personnel.

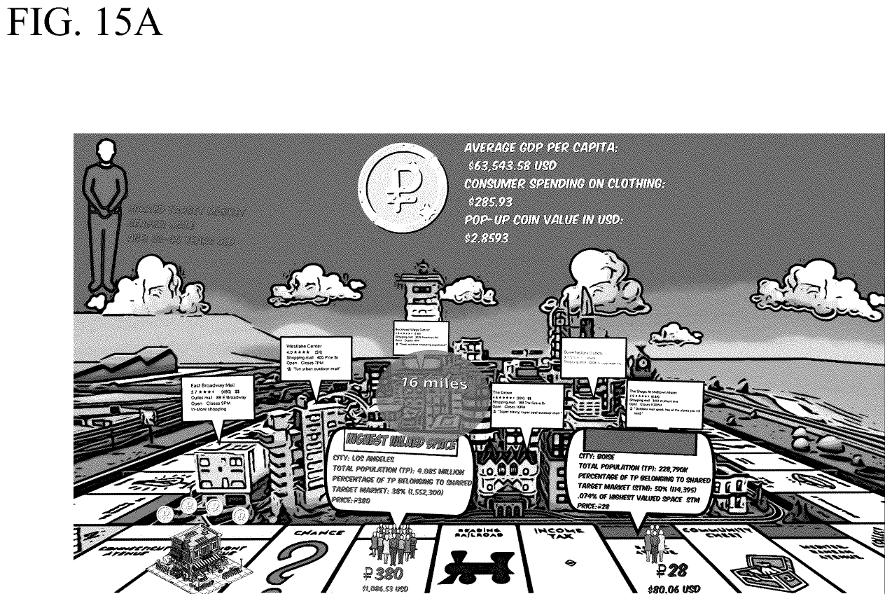

FIG. 15A is a depiction of a concept gamification and augmented reality advertisement space trading method. The virtual items in the game include the gameboard spaces or virtual real estate that are geotagged to a geophysical location which are denoted by the location tags above the buildings in the image, which further represent a general location for an augmented reality ad campaign. The trading game may be like the board game Monopoly, as exemplified in the image, wherein the object of the game is to buy up property spaces that are geotagged to locations with a relatively percentage of the total population that represents a target market. The game may further allow for the procurement of virtual property improvements such as but not limited to virtual buildings or modular construction items that resemble a pop-up storefront as denoted by the virtual property improvement to the left of the question mark gameboard space titled “chance.” The size and game currency value of the said virtual property improvement translates to an “ad reach” or range that may determine the number of locations within a given area at which an augmented reality ad may be displayed on geotargeted nodal devices, as depicted in the image by the opaque circle titled “16 miles,” indicating that the value of the said property improvement translates to a 16-mile radius of augmented reality ad space. The virtual space game dollar value may be determined according to a programmable dataset valuation mechanism; for example, if the most valuable virtual property space (or “Highest Valued Space) is geotagged to Los Angeles, California having a total population of 4.085 million people with 38% percent of the total population belonging to a target market that is relatively shared amongst the players of a given game, as indicated in the image, the game dollar price of the highest valued space could be equal to the percentage number multiplied by ten, bringing the price of the highest valued virtual property space to 380 game dollars as indicated below the population icon located under the “high valued space” tag. After the game dollar value of the highest valued virtual property space has been calculated according to programmable mathematical logic, the game dollar value of the remainder of the spaces are determined according to a relative valuation system; for example, if a virtual property space is geotagged to Boise, Idaho having a total population of 228,790 people of which 50% or 114,395 belong to a shared target market, the relative valuation mechanism would determine that the shared target market population of Boise, Idaho is 0.074% of the shared target market population in Los Angeles, California thereby multiplying the game dollar value of the highest valued virtual space (380 game dollars) times 0.074% which would bring the game dollar value of the virtual space to 28.12 game dollars respectively, as indicated in the image to the right of the “highest valued space” tag. The fiat valuation of a game dollar may also be determined via the programmable implementation of a dataset valuation system; for example, if the players' collective product categories associated with their user profiles fall into a specific or general consumer price index group such as “clothing and footwear,” the system may extract data pertaining to the GDP per capita or the average household expenditures allocated to this specific category, as exemplified in the image near the depiction of the game dollar coin at the top center of the image. For example, if the average household expenditures allocated to this consumer price index group is $285.93 per year, the system may then price a single unit of game currency at $2.86 per game currency token, bringing the fiat currency value of the highest valued virtual property space to $1,086.53, and the fiat value of the virtual property space geotagged to Boise, Idaho to $80.06 respectively, as indicated in the image below the game dollar value of the respectively tagged gameboard spaces. The procurement of a virtual space may actuate an augmented reality ad template for the creation of augmented reality ads much like that described above. The game may further include a programmable turn-taking method by which players may or may not “land on,” “visit” or “rent” virtual spaces that are owned by other players, in this respect the shelf space or commercial space trading aspect of this system is simulated in the virtual reality/virtual gaming environment.

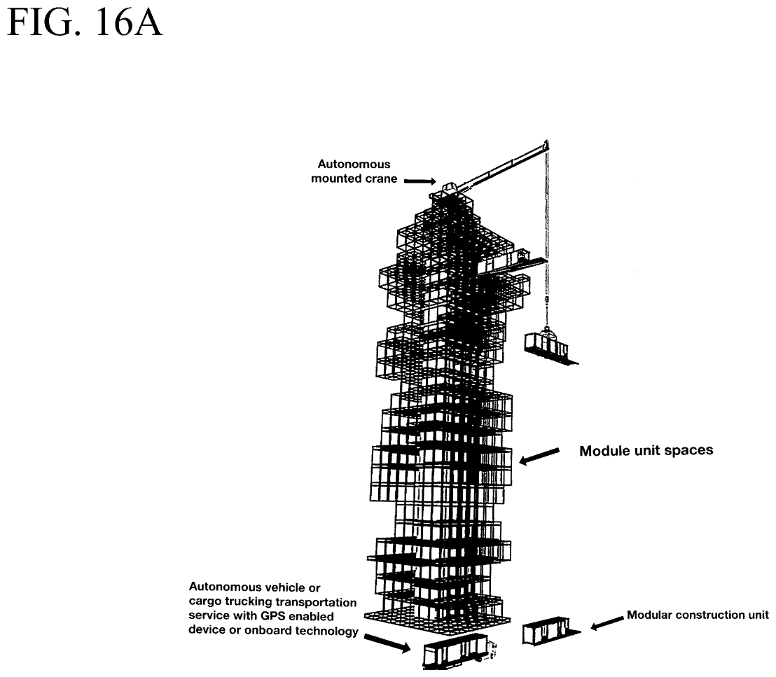

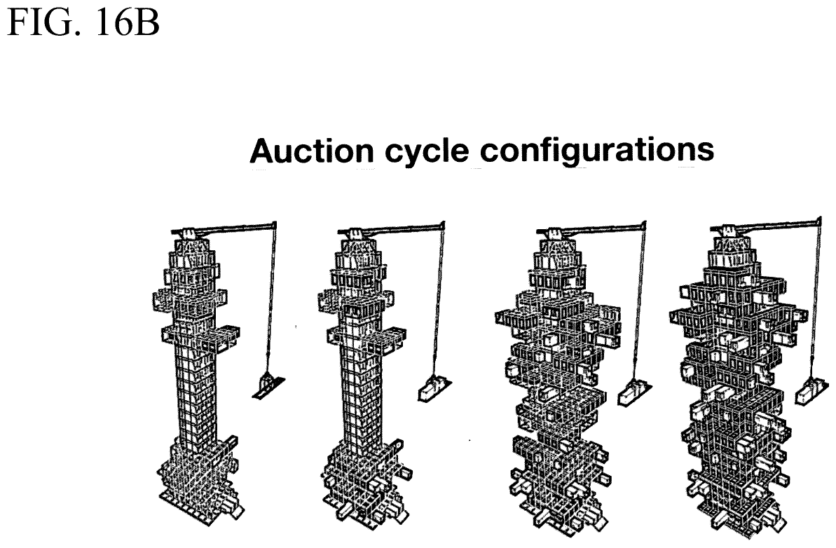

FIG. 16A is a depiction of a modular tower frame composing a module sensor system and a robotic mounted crane, for the emplacement and extraction of modular construction units or modified shipping containers that are transported to and from the site according to floorspace auction cycles.

FIG. 16B is a variation of FIG. 16A wherein the image shoes various building configurations that can appear through modular space auction cycles.

Wireless communication may be provided using any of a variety of communication protocols and/or wireless communication networks, including e.g. GSM, GSM-R, UMTS, TD-LTE, LTE, LTE-Advanced Pro, LTE Advanced, Gigabit LTE, CDMA, iDEN, MVNO, MVNE, Satellite, TETRA, WiMAX, AMPS TDMA, Roaming SIM, DC-HSPA, HSPA, HSPA+, HSDPA, G, 2G, 3.5G, 4G, 4.5G, 5G, 5.5G, 6G, 6.5G, VoLTE, EDGE, GPRS, GNSS, EV-DO, 1.times.RTT, WCDMA, TDS-CDMA, CDMA2000, CSFB, FDMA, OFDMA, PDMA, AMPS, EV-DO, DECT, IS-95, NMT, UMTS, MPLS, MOCA, Broadband over Power Lines, NB-IoT, enhanced MTC (eMTC), LTE-WLAN, ISDN, Microwave, Long Range Wifi, Point to Point Wifi, EC-GSM-IoT, LTE-M, NB-IoT, Evolved Multicast Broadcast Multimedia Service (eMBMS) and LTE-Broadcast (LTE-B),

PRINT LIMITER token creation instructions module 1833, PRINT LIMITER 1360A-1 Examples of hash algorithms include MD 5, SHA 1, SHA 256, RIPEMD, and Keccak-256 IMPL token transfer instructions
CUSTODIAN 3 smart contract, CUSTODIAN 2 smart contract

The elliptic curve Diffie-Hellman (ECDH) key agreement scheme; (2) The Elliptic Curve Integrated Encryption Scheme (ECIES), also known as Elliptic Curve Augmented Encryption Scheme or simply the Elliptic Curve Encryption Scheme; (3) The Elliptic Curve Digital Signature Algorithm (ECDSA) which is based on the Digital Signature Algorithm; (4) The deformation scheme using Harrison's p-adic Manhattan metric; (5) The Edwards-curve Digital Signature Algorithm (EdDSA) which is based on Schnorr signature and uses twisted Edwards curves; (6) The ECMQV key agreement scheme which is based on the MQV key agreement scheme; and (7) The ECQV implicit certificate scheme.

Compatible coins that may represent an NFT may include but are not limited to, SVCoin, Energy Master Limited Partnership (Energy MLP) Tokens, B Real Estate Investment Trust (REIT) Token, Venture Capital (VC) Tokens, Private Equity (PE) Tokens, Digital Certificate of Deposit (CD) Tokens, Digital Bond Tokens, Peer-to-Peer Lending (P2P) Tokens, Crowdfunding (CF) Tokens, Real Estate Crowdsourcing Tokens, Artistic/Digital Rights Payment Tokens, cryptokitty, everdragon, crypto baseball, mycryptoheroes, marblecard, bitcoin, ether, litecoin, bitcoin cash, zcash, Gemini dollar, Tether, UNUS SED LEO, Maker, Chainlink, Crypto.com, Basic Atten, USD Coin, OmiseGo, BitTorrent, Holo, TrueUSD, Pundi X, Ox, Augur, Huobi Token, Auroa, Zilliqa, Dent, Quibitica, KuCoin Shares, Paxos, IOST, HedgeTrade, ThoreCoin, Insight Chain, Egretia, Nash Exchange, Mixin, Enjin Coin, aelf, Status, VestChain, Solve, MidSafeCoin, Golem, WAX, Dai, Santiment Network Token, Maximine Coin, Waltonchain, ODEM, EDUCare, Lambda, Loom Network, NEXT, DigixDAO, Loopring, Quant, Clipper Coin, Orbs, Nexo, Ignis, Revain, Fusion, Japan Content Token, QASH, Power Ledger, Celer Network, Poopulous, Enigma, Buggyra Coin Zero, Bancor, LATOKEN, Matic Network, Fantom, Cortex, Kyber Network, Digitex Futures, Ren, Ecoreal Estate, Polymath, QuarkChain, Arcblock, Storj, Statis Eurs, Bread, FunFair, Sythetix Network Token, IoTeX, CRYPTO20, Gas, IoT Chain, Centrality, Veritaseum, Iconomi, RIF Toekn, Eidoo, Bibox Token, LINA, Hyperion, UGAS, XMax, Cred, Civic, iExecRLC, Mithril, Metal, TenX, JPM Coin, Stellar, Tezos, Dogecoin, Ripple, EOS.
Vendors 140 may accept digital assets as payment
https://www.blockchainfirm.io/

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies such as but not limited to a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform, the AutoCAD™ operating system, the AutoLISP™ operating system, the AutoDesk™ operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable cross-platform API integration tools, communication protocols, web scraping/web crawling tools, data mining tools, or software development kits may be used in accordance with the various embodiments of the invention, including but not limited to Opengl ES, Instant Placement API, ARCore, Vuforia, Wikitude, ARKit, ARToolkit, Open platform communications (OPC), OpenSceneGraph, GPS Suport (Geolocation), Simultaneous Localization and Mapping (SLAM) Support, Maxst, Layar, RESTful, Message Queuing Telemetry Transport (MQTT), Junaio, Mixare, Workato, QuickBooks Bi-Directional Synchronizer, SERENEDI, DreamFactory, Supermetrics, Hevo, Cyclr, ActiveBatch, Adverity, Tonkean, Branch.io, ScorecardResearch (Comscore), Crashlytics, Graph, Google ads, Appsflyer, Appcelerator, Kinvey, Google Maps, Goole Analytics, Weather App API, Firebase, Gmail API, Foursquare API, Amazon AWS, Appery.io, Flurry, Apteligent, Cittercism, Fiksu, Flurry, Gigya, Kochova, Localytics, Adobe dtm, Applovin, Demdex, Mopub, Parse, Mixpanel, Tapstream, Tune, Adjust, Adcolony, Admarvel, Cittercism, Moatads, New Relic, Urbanairship, Uservoice, Zendesk, Applovin, Food Fact API, Twilio API, Android Package Kit, 6FA, REST API, Simple Object Access Protocol (SOAP), HTTP protocol, Open API Standard (Swagger), Representational State Transfer (REST) protocol, Remote Procedure Call (RPC) protocol, GraphQL, UserExperior, Adobe Analytics, CleverTab, Mixpanel, Amplitude, MoEngage, Apptimize, UXCam, Integrate.io, Rapid Miner, Orange, Weka, KNIME, Sisense, SSDT (SQL Server Data Tools), Apache Mahout, Oracle Data mining, Rattle DataMelt, IBM Cognos, IBM SPSS Modeler, SAS Data Mining, Teradata, Board, Dundas BI, Talend Data Fabric, Qlik, SAS Visual Data Mining and Machine learning, Oracle Machine Learning on Autonomous Database, Apache Spark, Hadoop MapReduce, Scikit-learn, Pandas, H30, Amazon EMR, Azure ML, Google AI Platform, PyTorch, TensorFlow, Matplotlib, ggplot2, Anaconda, R Software Environment, Shogun, DataMelt, Natural Language Toolkit, GNU Octave, GraphLab Create, ELKI, Apache UIMA, TANAGRA, Rattle GUI, CMSR Data Miner, OpenNN, Dataiku DSS Community, DataPreparator, LIBLINEAR, Chemicalize.org, Vowpal Wabbit, mlpy, Dlib CLUTO, TraMineR, ROSETTA, Fityk, ADaMSoft, Sentic API, ML-Flex, Databionic ESOM, MALLET, StreamDM, Adam, MiningMart, Modular toolkit for Data Processing, Jubatus, LIBSVM, Arcadia Data Instant, R-Programming, Meaning Cloud, Gensim, AYLIEN, Apache OpenNLP, Google Cloud Natural Language API, Screaming Frog, Sitebulb, Oncrawl, Netpeak Spider, Open search server, Helium scraper, Website auditor, UiPath, BUbiNG, Dexi.io, Apache Nutch, Scrapy, Pyspider, Webmagic, Crawlee, Node Crawler, Beautiful Soup, Nokogiri, Crawler4j, MechanicalSoup, Heritrix, Apify, Octoparse, 801egs, Parsehub, Visual Scraper, WebHarvy, Content Grabber (Sequentum), Cyotek Webcopy, HTTrack, Getleft, Scraper, OutWit Hub, Scrapinghub (Zyte), Dexi.io, Webhose.io, Import,io, Spinn3r (datastreamer.io), Puppeteer, Webharvy, NetSpeak Spider, Open Search Server, GNU Wget, Norconex, WebSphinx, Mozenda, Common Crawl, Semush, RAWG, WebVR, WebXR API, WebRTC API, Pointer Lock API, Gamepad API, Web Workers API, WebGL, Web Audio API, CometChat, Discord, Chicken Coop API, PokeAPI, IGDB API, StreamWeb API, Dota2 API, OpenGL, UltraEdit, Quixy, Embold, Jira, GeneXus, Zoho Creator, Delphi, Atom, Cloud 9, GitHub, NetBeans, Bootstrap, Node.js, Bitbucket, Codecharge Studio, CodeLobster, Codenvy, Angular JS, Eclipse, Dreamweaver, Crimson Editor, Zend Studio, CloudForage, Azure, Spiralogics Application Architecture (SAA), Link, SendBird, Clickup, Vim, Docker, Axure, Studio 3T, Collaborator, SQL Sentry, DbSchema, Apache NetBeans, Zend Studio, HTML5 Builder, Visual Online, Kwatee, Data Studio, DevOps Tools, UML Tools, Eclipse, Postman, Visual Studio, Zapier, Kotlin, Mockplus, Headspin, Buddy, IntelliJ IDEA, Apple ARKit, Wikitude, Kudan, MaxST, EasyAR, Onirix, Pikkart AR SDK, DeepAR, MixedReality Toolkit (HoloLens), Xzimg, DroidAR, AR.js, HP Reveal Studio, BlippBuilder, AugMara CMS, Amazon Sumerian, Augmented Pro, Augment, Unity 3D, Unreal Engine 4, Blender, Amazon Lumberyard, CryEngine, AppGameKit, Occulus Medium 2.0, Google SketchUp, Tilt Brush, Vizor.io, Janus VR, React 360, A-Frame, Autodest 3ds Max.

Any suitable programming language (client-side and/or server side) and computing frameworks may be used in accordance with the various embodiments of the invention. The programming language used in the computing framework may include or interface with such but not limited to, Lua, ScummVM, Shsql, F, Sweave, M, Simulink, knitr, Coq, STereoLithography/Standard Tessellation Language (STL), G-code, ladder logic, function block diagram, programmable logic controller (PLC), Mastercam, Fusion 360, Ultimaker Cura, Autodesk Fusion 360, Supervisory control and data acquisition (SCADA), Racket, Robot Operating System, Internet of Things (IoT) computing frame works, Botpress, Rasa, Microsoft Bot Framework, Dialogflow, Morse Code, BigTable, SimleDB, NoSQL, TypeScript, Solidity, Css3, Exocompilation, Exo, BLAS, cuDNN, Güting's language, SQL^{ST}, CUDA, TQuel, MKL, Gemmini, Gravity, Imba, Vyper, Morfa, Objeck, Erlang, CoffeeScript, eXtensible Markup Language (XML), OpenGIS Consortium (OCG), Geographical Markup Language (GML), Structured Query Language (STQ), Programming Language for SpatiO-Temporal data Streaming applications (PILOTS), ArcGIS, Node.js, Unity, ASP.NET, Ballerina WS02, F #, Ajax, TensorFlow, for example. Computer aided design programming languages may include, SolidWorks, PRO/E, CATIA, NX, Map 3D, AutoCAD, AutoLISP, Parasolid, OpenCascade (FOSS), for example. Illustratively, the programming language used may include APL, Basic, C, C++, Visual C++/CLI, Visual Basic .NET, Visual C#.NET, VBA, Object ARX, Visual C++ 6.0, COBOL, dBase, Forth, Fortran, Java, D, Less.js, Scala, JOLT, Clojure, Modula-2, Pascal, Prolog, REXX, Assembly language, Lua, PHPoC, Crystal, Rholang, Jupyter Notebook, Logica, Visual Basic, and/or JavaScript, for example. Client-side and server-side programming languages and frameworks may further include or interface with such but not limited to, Lower-Level, Lisp (LLL), Unity Script, Boo, Vyper, Simplicity, Varna, Apache Kafka, RabbitMQ, Obsidian, Solidity, WebAssembly (WASM), Rholang, Michelson, Plutus, Julia, R, LISP, Sophia, JSON, Swift, Kotlin, Lua, Laravel, Containers, Golang, Spatio-temporal query language (STQL), Artificial Intelligence Markup Language (AIML), Smalltalk, Prolog, Bash, STRIPS, Planner, POP-11, Haskell, Wolfram, MATLAB, Shell, Object-Oriented Programming (OOP), Interactive Data Language (IDL), Groovy, Delphi, Ada, Lua, ALGOL, Clojure, Visual Basics, COBOL, Objective-C, NIM, OCAML, Reason, RUST, Pony, ELM, Elixir, Elixir v1.12, Syntax, Scheme, NODEJS, PV-Wave, Dart, GDL, Programming Language of Solid Modeling (PLaSM), Python, Cassandra, HTML, TypeScript, JavaScript, Java, MySQL, SQL, CSS, PUP, Ruby, Pascal, Query, XHP, Hack, SAS, Octave, Erlang, HBase, MariaDB, Bigtable, PostgreSQL, HBase, MongoDB, Perl, SQL Server, CakePHP, Metor, AngularJS, Ruby on Rails, Laravel, Meteor, Vue.js, Express.js, Coldelgniter, Phalcon, Symfony, Flask, ASP.NET, Gatsby, Zikula, Yii, Apache Wicket, TurboGears, Grails, Yesod, ASP.NET Core, Laminas, Sinatra, Svelte, Play Framework, React, Flutter, React Native, Scrum, Extreme Programming (XP), Scaled Agile Framework (SAFe), Adaptive Software Development (ASD), Featured Driven Development (FDD), Lean Software Development (LSD), Disciplined Agile (DA), NodeJS, Spring, TensorFlow, Xamarin, Spark, Cordova, Ember, Vue, Express, Horde, Zend, Web2py, Lumen, Phalcon, FuelPHP, Grok, Mojolicious, Fat-Free Framework, Sencha Ext JS, Nuxt.js, Phoenix, CodeIgniter, PHPixie, Javalin, Silex, Caliburn Micro, Iconic, Xamarin, Iconic, PhoneGap, Corona (Solar 2D), jQuery Mobile, Mobile Angular UI, Appcelerator Titanium, Swiftic, NativeScript, Framework7, Rachet, Neural Network Libraries, Apache MXNet, ML.NET, Infer.NET, Accord.NET, Chainer, Horovod, H20 Q, Robot Framework, Gauge, Pytest, Jest, Mocha, Jasmine, Nightwatch, Protractor, Cypress, TestProject, Galen Framework, WebDriverIO, OpenTest, Citrus, Karate, Truffle, Scrapy, Embark, Etherlime, OpenZeppelin Contracts, Brownie, Create Eth AP, Exonum, Hyperledger, Fabric, Iroha, Sawtooth, Besu, Corda, MultiChain, Onsen UI, SiteWhere, Electron, Svelte, Aurelia, Mithril, Bulma, Microdot, Rapidoid, Ktor, Scalatra, Toolatra, Django, Cosmos DB, Voldemort, Redis, Scala, Go, C#, C, and XHP. Machine languages may include or interface with such but not limited to MATLAB, Automatically Programmed Tool (APT), G&M Code, Ada, Scratch, Basic, LISP, Prolog, Pascal, Fortran, Ruby, NET, Hardware description Languages (HDL), Assembly (ASM), Swift, Java, Python, C, Solidity, CX, Dart, Pony, Typescript, Nim, Python 3, PureScript, Configuration Space (C-space) programming language, Configuration space obstacles (C-Obstacles) programming language. Data exchange programming languages may include, STEP, IGES, STL import/export. Computing frameworks may include Backstage, Buildkite, SonarQube, Puppet, Terraform, Libgdx, Reactjs, Laravel, PythonOCC, iOS Arkit, ARcore, Simple CV, Vuforia, Kudan, Wikitude SDK, HADOOP CASSANDRA, GOOGLE BIGTABLE, ROS. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claim.

1) A mobile, computer readable, programmable, non-transitory, cloud computable, machine learning, nonfungible token valuation trading infrastructure and/or distributed ledger wherein the improvement comprises:
a) the georeferencing of various population densities or target markets via the programmable implementation, or the interoperation or integration of techniques or technologies such as but not limited to, opensource distributed computing frameworks, cloud-based geostatistics, computer readable geospatial demographics, cloud-based data analytics, cloud-based API data engineering technology, machine learning algorithms, cookie compliance data, campaign management analytics technology, social graph technology, computer readable user statistics, computer readable conversation tracking data, computer readable demographic data, serosurveillance technology, computer readable spatial analysis data, biometric surveillance technology, sentinel surveillance technology, user behavior tracking technology, relative predictive modeling, spatiotemporal data engineering, computer readable temporal querying data, computer readable polling data, programmable footfall data engineering, web scraping, web crawling, or API communication protocols, or any combination or variation thereof in the mining of data that represent dataset variables within a dataset valuation system as part of a dataset monetization or tokenization mechanism, or in the mining of data represented as data layers of an interactive geographic information system map, or of a heat map, or in the mining of data that represent dataset criteria selection options that are part of a bid weighting method of an auction environment, or in the mining of data that represent a target market;
b) computer readable instructions configured to receive a building information model from a design computing device or from a computer assisted design communication protocol, or from a game engine, further configured to convert metadata representing the virtualizations of shelf space or floorspace sectors, within a computer readable building model, into a nonfungible token and to generate a hash vale thereof,
c) the use of social graph technology and criterial data engineering, and/or criterial data analysis, as part of a consensus protocol within a nonfungible token auction or sales environment of a private blockchain, or of a public blockchain, or of a hybrid blockchain, or a temporal blockchain, or of a multichain, wherein the nonfungible token represents the metadata of a computer-readable building model or of a computer-assisted design communication protocol, wherein the metadata further represents shelf space or floorspace as a digital commodity or virtual product, that may or may not further represent a nondigital real-world/physical item or real-world/physical space;
d) the use of social media user behavior data extracts and social graph data and criterial data engineering, and/or criterial data analysis, as part of dataset valuation method or as part of a dataset monetization or tokenization method within a nonfungible token trading environment wherein a nonfungible token is represented by the static imagery, video content, or audio-visual content that contains the digital likeness of a person;
e) the configuration for creating an auction or sales environment as part of a private blockchain, a public blockchain, a hybrid blockchain, or a multichain, according to social graph datasets and criterial engineering, and/or criterial data analysis consensus protocols, for the trading of nonfungible tokens or digital items wherein the nonfungible token or digital item represents the metadata of a computer readable building model or of a computer assisted design communication protocol, wherein the metadata further represents modular cell space, shelf space or floorspace as a digital commodity or virtual product, that may or may not further represent a nondigital real-world/physical item, or real-world/physical space, or persons;
f) the method further comprising a computer readable configuration for transmitting the bill of material to a supply computer device, informing a third-party supplier to deliver the materials to the construction site, receiving a material delivery information, receiving an internal and external inspection information, receiving regulatory compliance information, receiving insurance information and receiving labor information, debiting a first account associated with the project and crediting a second account associated with the project, creating records or certificates representing various verifications of stages of the product staging project and storing the records or certificates on a distributed ledger or on a live feedback or progress reporting system of a parallel reality image recognition technology;
g) the method further comprising a design computing terminal including a game terminal, or a virtual design environment for the customization and design of a modular unit or of modified shipping container construction units, wherein the metadata of a virtual design environment, or of a game engine computing framework, of the said building design computing system may be inputted or transmitted to 3D-printing computer devices, automated painting system computing devices, or modular assembly line computing devices, or any combination or variation thereof, for the automated fabrication of modular, modified, or prefabricated construction units;
h) computer readable instructions for receiving remote sensing, temporal resolution, and pattern recognition data as part of a communication protocol for generating and transmitting an augmented reality display of staging and/or design instructions to a third party according to metadata representing a building design model, wherein remote sensing, or temporal resolution, or pattern recognition data of a third party augmented reality display, is further configured to generate live stage project completion status feedback.

2) A mobile, computer readable, programmable, non-transitory, cloud computable, machine learning, nonfungible token valuation trading infrastructure and/or distributed ledger of claim 1, wherein the method is applied to an event planning system, a commercial event planning system, a pop-up event planning system, or an event planning system.

3) A mobile, computer readable, programmable, non-transitory, cloud computable, machine learning, nonfungible token valuation trading infrastructure and/or distributed ledger of claim 1, wherein the method is applied to a real estate trading system.

4) A mobile, computer-readable, programmable, non-transitory, cloud-computable, machine learning, non-fungible token valuation trading infrastructure and/or distributed ledger of claim 1, wherein the method is applied to a real estate trading system for the purposes of valuing and trading non-fungible tokens that represent properties, building structures, or real estate assets, using data mining techniques and technologies such as but not limited to, open-source distributed computing frameworks, cloud-based data analytics, cloud-based API data engineering technology, machine learning algorithms, cookie compliance data, campaign management analytics technology, social graph technology, computer-readable demographic data, serosurveillance technology, sentinel surveillance technology, user behavior tracking technology, relative predictive modeling, computer-readable polling data, programmable footfall data engineering, web scraping, web crawling, or API communication protocols, or any combination or variation thereof.

5) A mobile, computer readable, programmable, non-transitory, cloud computable, machine learning, trading infrastructure and/or distributed ledger wherein a dataset valuation method, or a dataset monetization method, or a dataset tokenization method, is applied in the valuation of a single monetary unit of a fiat currency, or of a digital currency, whereby the value is artificially deflated or is artificially inflated using mathematical logic in an amount an amount that reflects datasets that are extracted using data mining techniques and technologies such as but not limited to, opensource distributed computing frameworks, cloud-based geostatistics, computer readable geospatial demographics, cloud-based data analytics, cloud-based API data engineering technology, machine learning algorithms, cookie compliance data, campaign management analytics technology, social graph technology, computer readable user statistics, computer readable conversation tracking data, computer readable demographic data, serosurveillance technology, computer readable spatial analysis data, biometric surveillance technology, sentinel surveillance technology, user behavior tracking technology, relative predictive modeling, spatiotemporal data engineering, computer readable temporal querying data, computer readable polling data, programmable footfall data engineering, web scraping, web crawling, or API communication protocols, or any combination or variation thereof.

6) A computerized system or method of converting datasets of a data mining system into digital currency, or into variables of a digital currency dataset valuation method, or in the artificial deflation or inflation of a fiat currency, using mathematical logic as part of a non-fungible token trading or auction platform, or as part of a digital item trading or auction platform, or as part of a trading or auction platform, or as part of a blockchain auction or trading platform, or as part of a temporal blockchain trading or auction platform, or as part of a directed acyclic graph (or local blockchain) trading or auction platform, or as part of a gaming environment, wherein the data mining technique comprises technologies such as but not limited to, opensource distributed computing frameworks, cloud-based geostatistics, computer readable geospatial demographics, cloud-based data analytics, cloud-based API data engineering technology, machine learning algorithms, cookie compliance data, campaign management analytics technology, social graph technology, computer readable user statistics, computer readable conversation tracking data, computer readable demographic data, serosurveillance technology, computer readable spatial analysis data, biometric surveillance technology, sentinel surveillance technology, user behavior tracking technology, relative predictive modeling, spatiotemporal data engineering, computer readable temporal querying data, computer readable polling data, programmable footfall data engineering, web scraping, web crawling, or API communication protocols, or any combination or variation thereof.

7) A computerized system or method of monetizing datasets and/or configuring datasets into variables of a digital currency dataset valuation mathematical model.

8) A computerized system method wherein the georeferencing of various population densities or target markets via the programmable implementation, or the interoperation or integration of techniques or technologies such as but not limited to, opensource distributed computing frameworks, cloud-based geostatistics, computer readable geospatial demographics, cloud-based data analytics, cloud-based API data engineering technology, machine learning algorithms, cookie compliance data, campaign management analytics technology, social graph technology, computer readable user statistics, computer readable conversation tracking data, computer readable demographic data, serosurveillance technology, computer readable spatial analysis data, biometric surveillance technology, sentinel surveillance technology, user behavior tracking technology, relative predictive modeling, spatiotemporal data engineering, computer readable temporal querying data, computer readable polling data, programmable footfall data engineering, web scraping, web crawling, or API communication protocols, or any combination or variation thereof, in the mining of data that represent dataset variables within a dataset valuation system, or in a dataset monetization system, or in a dataset tokenization system, using mathematical logic wherein a digital asset that may further represent geophysical space, real estate, real-world/physical items, the likeness of a person, personnel, or real-world/physical space, is assigned a monetary valuation respectively, wherein the digital asset is a nonfungible token, as part of a computer readable configuration.

9) A computerized method wherein the georeferencing of various population densities or target markets via the programmable implementation, or the interoperation, or integration of techniques or technologies such as but not limited to, opensource distributed computing frameworks, cloud-based geostatistics, geospatial demographics, cloud-based data analytics, cloud-based API data engineering technology, machine learning algorithms, cookie compliance, campaign management analytics technology, social graph technology, user statistics, conversation tracking, demographics, serosurveillance technology, biometric surveillance technology, sentinel surveillance technology, user behavior tracking technology, relative predictive modeling, computer readable polling data, spatiotemporal data engineering, temporal querying, footfall data engineering, web scraping, web crawling, or API communication protocols, in the mining of data that represent dataset variables within a dataset valuation system wherein a digital asset that may or may not further represent geophysical space, real estate, real-world/physical items, persons, or real-world/physical space, or any combination or variation thereof, wherein datasets apply a weight to a bid as part of the mathematical logic in a computer readable configuration.

10) A mobile, computer readable, programmable, non-transitory, cloud computable, machine learning, trading infrastructure and/or distributed ledger wherein static imagery containing a person's likeness, or wherein audiovisual content containing a person's likeness, or wherein videographic content containing a person's likeness, a person represented by a node denoted by relative influence or status on a computerized social platform, wherein said content containing said person's likeness is a digital product that is assigned a hash value and is further represented as a nonfungible token within a distributed ledger or blockchain infrastructure, according to computer readable instructions.

11) A method of claim 9 wherein a said person of a relative social media influence or status is identified as a “social media influencer seller” node within a blockchain and/or trading infrastructure, wherein the static imagery, videographic content, or of audiovisual content that contains the likeness of a person represented by a said social media seller node is further represented as a nonfungible token, and wherein computer readable datasets representing said social media influencer seller node's social platform constituency user behavior data, further represents dataset variables within a dataset valuation mode, or within a dataset monetization model, or within a dataset tokenization model, that is implemented in the mathematical logic of a computer readable configuration for assigning a monetary value to said static imagery, videographic, or audiovisual content digital items that are made eligible for sale as a nonfungible token according to computer readable instructions.

12) A method of claim 9 wherein the georeferencing of various population densities or target markets via the programmable implementation, or the interoperation, or the integration of techniques or technologies such as but not limited to, opensource distributed computing frameworks, cloud-based geostatistics, computer readable geospatial demographics, cloud-based data analytics, cloud-based API data engineering technology, machine learning algorithms, cookie compliance data, campaign management analytics technology, social graph technology, computer readable user statistics, computer readable conversation tracking data, computer readable demographic data, serosurveillance technology, computer readable spatial analysis data, biometric surveillance technology, sentinel surveillance technology, user behavior tracking technology, relative predictive modeling, spatiotemporal data engineering, computer readable temporal querying data, computer readable polling data, programmable footfall data engineering, web scraping, web crawling, or API communication protocols, or any combination or variation thereof, in the mining of data for a comparative analysis between the said social media seller node's social platform constituency user behavior data, and datasets representing a “buyer” node's online constituency data or target market data, wherein the computer readable instructions configure an optimization of digital items to be sold as nonfungible tokens, that are presented on a device representing a buyer node, according to relative data compatibility scoring and computer readable instructions.

13) A method of claim 9 wherein static imagery or audiovisual content containing a person's likeness, a person of relative influence or status on a computerized social platform, is applied to augmented reality content that is transmitted to a geotargeted node or device that is capable of vision-based object registration for real-time image overlay, a said node or device within a geographical location, transmitted from a node representing a “purchaser” node that indicates the purchaser of a nonfungible token representing said static imagery, videographic content, or audiovisual content, according to computer readable instructions.

14) A computer-implemented method for creating augmented reality content, or for creating augmented reality ad campaigns comprising:
a) A background for the template that comprises an interactive or non-interactive static imagery, or an interactive or non-interactive virtual rendition, or an interactive or non-interactive satellite imagery of a prospective geophysical event location, or a geophysical location not associated with any prospective event;
b) metadata generated from the background onto which NFT art or digital content transmitted via API or TCP/IP with a digital art or NFT auction or trading platform, or from an NFT art or digital art auction or trading platform embodiment, or digital art or content from a photo archive of a device, may be superimposed; and
c) a preview display of an augmented reality ad campaign to display the metadata.

15) The method of claim 14, further comprising a plurality of remote geotargeted nodal devices that are capable of vision-based object registration for real-time image overlay; and/or devices that are capable of vision-based object registration for real-time image overlay and/or devices that are pairable with devices that specialize in vision-based object registration and real-time image overlay for augmented reality, or parallel reality experiences; a device node that represents a “target market” node.

16) The method of claim 14 further comprising:
a) a programmable mechanism for applying static imagery, videographic, or audiovisual content containing a person's likeness, or containing NFT art or digital content, to an augmented reality display template;
b) the display content being transmitted to a geotargeted node or device within a geographical location according to a communication protocol from a “buyer” node that indicates a purchaser of the nonfungible token representing said static imagery, videographic content, or audiovisual content that contains the likeness of a person that is represented by a “social media influencer seller” node, or from a node that denotes a “retailer” user.

17) A computer-implemented method for monetizing datasets comprising: converting digital items, metadata, imagery, video content, audiovisual content, or virtualizations of a geophysical space, real estate, real-world/physical items, persons, or real-world/physical space, into nonfungible tokens; assigning a computer-readable monetary value to each nonfungible token according to a dataset valuation model that monetizes datasets by mining them in the computer-readable implementation of methods and technologies; and facilitating the trading of the nonfungible tokens within a virtual auction or sales environment according to computer readable instructions.

18) The computer-implemented method of claim 17, wherein the datasets representing a target market or a constituency associated with a user profile, a user profile representing a retail business owner, or a retail business owner representative, or a retail business owner representative of a joint-user or multi-user account, are mined using method and technologies such as but not limited to, the georeferencing of various population densities or target markets via the programmable implementation, or the programmable interoperation, of techniques and technologies such as but not limited to opensource distributed computing frameworks, cloud-based geostatistics, computer readable geospatial demographics, cloud-based data analytics, cloud-based API data engineering technology, machine learning algorithms, cookie compliance data, campaign management analytics technology, social graph technology, computer readable user statistics, computer readable conversation tracking data, computer readable demographic data, serosurveillance technology, computer readable spatial analysis data, biometric surveillance technology, sentinel surveillance technology, user behavior tracking technology, relative predictive modeling, spatiotemporal data engineering, computer readable temporal querying data, computer readable polling data, programmable footfall data engineering, web scraping, web crawling, or API communication protocols, or any combination or variation thereof, from public or private sources.

19) The computer-implemented method of claim 17, wherein the virtual auction or sales environment includes a temporal blockchain and virtual auction spaces, and wherein a single auction space may comprise a plurality of listing of a single temporal blockchain.

20) The computer-implemented method of claim 19, wherein the auction-specific single-use tokens are relatively priced for auction participation as part of the programmable token output process according to a computer-readable bid weighting mechanism by which criteria inputs define a preferred bidder relative to criteria entries of a user profile, a user profile representing a bidder.

21) A computer-implemented method for trading retail space, retail floorspace sectors, or retail shelf space comprising: selling such retail space, retail floorspace sectors or retail shelf space as digital items that are virtual renditions, imagery, or metadata, imported or translated from a building information model of a design computing device, or from a computer-assisted design technology, or from a virtual design environment, or from an online product repository; representing such digital items, metadata, or virtual renditions as nonfungible tokens within a virtual auction or sales environment associated with a cryptographic hash function; and facilitating the trading of the nonfungible tokens within the virtual auction or sales environment according to computer-readable instructions.

22) The computer-implemented method of claim 21, further comprising implementing social graph technology as a method of generating a shopping experience within a virtual auction or sales environment, wherein digital item listings or auction lots that represent nonfungible tokens are optimized according to user profile data correlations within a plurality of users, data correlations that may identify a shared target market or other trends and patterns shared between a plurality of user profiles.

23) computer-implemented method of claim 22, wherein the optimization of digital item listings or auction lots includes showing items from sellers with correlations in target market data, or user profile data and/or criterial entries.

24) A nonfungible token trading system for physical/real-world retail space, commercial floorspace, or shelf space, the system comprising:
a) a metadata or cryptographic hash value associated with the nonfungible token, wherein the metadata or cryptographic hash value includes geocode data or other geo-specific data representing a geophysical location of the physical/real-world retail space, commercial floorspace, or shelf space;
b) a correlative data analysis engine that compares the geo-specific demography data to the target market profile data of registered users to optimize the order in which digital items are presented to a user during the shopping experience;
c) a programmable instruction engine that optimizes the nonfungible token digital products listed for sale or auction, associated with matching geo-specific data, to be presented amongst the first items displayed during the shopping experience.

25) The nonfungible token trading system of claim 24, further comprising:
a) an application programming interface (API) that may allow the system to interoperate with other nonfungible token virtual sales environments;
b) a multichain ledger or blockchain, or a temporal blockchain.

26) The nonfungible token trading system of claim 24, further comprising:
a) a virtual design environment that enables users to stock virtual shelving items or stage virtual space within a virtual design environment, with scaled virtualizations, imagery, virtual replicas, or virtual representations of physical/real-world product items, physical/real-world branding materials, or other physical/real-world materials;
b) a communication protocol that configures a bill of material including metadata, and transmits the data to a supply computer device, informing a third-party supplier to deliver the materials to the building or construction site, receiving a material delivery information, receiving an internal and external inspection information, receiving regulatory compliance information, receiving insurance information and receiving labor information, debiting a first account associated with the project and crediting a second account associated with the project, creating live feedback channel with records or certificates representing various verifications of stages of site construction and product staging and storing the records or certificates on a distributed ledger;
c) augmented reality image overlay generated from metadata configured into staging or stocking instructions during the virtual shocking or staging experience of an interior design phase within the virtual design environment.

27) The nonfungible token trading system of claim 26, wherein the metadata generated during the virtual shocking or staging experience is further configured into an augmented reality image overlay over real-time, real-world imagery, wherein image matching and remote sensing technologies are implemented in stocking or staging instructions generated by the metadata produced and stored on a device node during the stocking or staging experience of an interior design phase within a virtual design environment.

28) The nonfungible token trading system of claim 26, wherein the metadata generated during the virtual shocking or staging experience is further configured into an augmented reality image overlaying real-time, real-world imagery, and is transmitted to a mobile device that may be configured to receive a transmission of metadata to nodal devices that are capable of vision-based object registration for real-time image overlay, or to devices that are capable of vision-based object registration for real-time image overlay and that are pairable with a mobile device node, the device node associated with or representing a laborer, servicer, a contractor, or hired personnel.

29) The nonfungible token trading system of claim 26, wherein the metadata generated during the virtual shocking or staging experience is further configured into an augmented reality image overlaying real-time, real-world imagery, and is further implemented in a real-time feedback transmission that tracks progress via object registration or metadata image matching programming, wherein progress tracking includes communication protocols for receiving remote sensing, temporal resolution, and pattern recognition data as part of the communication protocol for generating and transmitting an augmented reality display of staging and/or design instructions to a third party device, a third party device associated with or representing a laborer, a service provider, a contractor, or hired personnel.

30) A programmable method and system for providing augmented reality games, comprising;
a) a cross-platform game engine for managing game-playing experiences; or an API and/or communication interface for external game engine interoperability;
b) a user interface for game developer users that includes an environment for game content creation, and an environment for the trading of game packages as digital items or as NFTs wherein the “game developer” user is represented as a “seller” node and a “retailer” user represents a “buyer” node;
c) a cloud-based machine-readable data storage medium for generating and updating interactive augmented reality games, and for storing device nodes and software products that are capable of vision-based object registration for real-time image overlay, pairable with software products that specialize in real-time image overlay for augmented reality experiences;
d) a distributed ledger in the form of a directed acyclic graph (DAG block), or of a spatiotemporal blockchain, or of a temporal blockchain, for storing data related to the augmented reality games.

31) The method of claim 30, wherein the game developer user interface a game application layer, an engine module, a system layer, a compiler, a datastore of geographic imagery, and a datastore of a 3D drawing and construction module for compiling in an augmented reality or parallel reality environment.

32) The method of claim 30, further comprising a direct messaging system or recruitment service technology by which a game developer user profile may be configured to receive metadata and customized game request information from a retailer user profile, thereby providing geophysical information relative to a prospective event or storefront location that may be implemented in the programmable augmented reality game development process as a template or background for the development of augmented reality game interaction and real-world integration rules.

33) The method of claim 30, further comprising a user interface for consumer users by which a location-based parallel reality or augmented reality gaming experience is actuated by spatiotemporal querying as part of a consensus protocol, and/or via online admissions or ticket purchasing as part of a proof-of-work protocol, wherein game features can be linked with activities in a real-world environment.

34) The method of claim 33, wherein augmented reality elements of the game are linked to physical markers or elements in a real-world environment, such as buildings, trees, signage, temporary construction items, murals, and landmarks, whereby the player is required to travel a geographical distance within a parameter to engage different parallel reality gaming elements.

35) The system of claim 33, wherein game tokens may be used in the purchase of real-world products or services being offered for sale at a participating pop-up event or pop-up retail storefront location, adding an incentive for game play that may result in the winning of game tokens as part of a location-based peer-to-peer network and player interaction protocol.

36) The system of claim 35, wherein game tokens represent a digital currency or a fait currency that may be exchanged on a spatiotemporal blockchain, or on a local blockchain (DAG block), or on a location-based temporal blockchain wherein data is stored on player nodes whereby game tokens may be saved for use at other participating pop-up events or pop-up storefront locations.

37) The system of claim 30, further comprising a live data-mining feedback channel wherein environmental data of a real-world environment is obtained from the camera of a plurality of player-nodes or a device pairable to a player-node, and self-correcting datasets are generated according to a spatiotemporal and temporal comparative analysis of images within a datastore by which game content translation may be improved in the hybridization of data extractions, generating and storing said data extractions on a game server and/or on a cloud server of the said game engine whereby the game development experience is enhanced.

38) A computer-implemented method and system for tracking and managing shipping containers and/or modular units, comprising:
a) an archiving system including a datastore for shipping containers and modular units procured by users of a “retailer” user interface;
b) integration of container tracking systems or container management systems using GPS, RFID, and IoT sensors to monitor the location and status of individual shipping containers or modified units, and store data about each container, such as its identification number, weight, and destination, capable of tracking its movement throughout the shipping process;
c) the temporal querying of onboard technology or cellular devices that are relative to the shipment of said containers;
d) “retailer” user profiles with container archives.

39) A computer-implemented method and system for scheduling modular cell space auction cycles, comprising;
a) an auction system for emplacement or extraction of modular units or modified shipping container units within a modular cell tower frame;
b) autonomous auctions operated by a deep learning algorithm that determines auction entry eligibility according to factors such as registered business and product category, product/service pricing, shipping container or modular unit archives, shipping container or modular unit procurement, shipping container or modular unit design mockup metadata, modular unit or modified shipping container feature requirements, modular unit or modified shipping container sizing requirements, and modular unit shipment and arrival estimates;
c) Auction lots being modular cells within a tower frame that limit auction entry eligibility to a preferred user as determined by deep learning algorithms or by criterial inputs of a designated auction manager that represents the user;
d) communication protocol with a robotic mounted crane computing system that may be configured to schedule the extractions and emplacements of modular units or modified shipping containers according to auction cycle data, as well as fleet management system data whereby the shipments of shipping containers or modular units are scheduled and managed.

40) A computer-implementable system or method for a natural language processing conversational agent, comprising:
a) an integration with system embodiments including robotics systems, fleet management systems, truck routing systems, virtual design environments, virtual real estate shopping environment, parallel reality environments, virtual sales and auction space environments, shipping container archiving systems, and SMS text messaging systems;
b) programming to process natural language inputs from an authorized user and perform functions through system integrations as a programmable consumer service assistant;
c) integration with a modular cell sensor network for reporting system issues and processing commands from natural language.

41) A computerized system and method for pop-up shop event planning wherein the method includes a design computing terminal comprising a virtual design environment, or a building design computing device, or a game terminal computing framework, or a computing framework for graphics rendering, physics simulation, input handling, audio processing, and networking as part of the programmable mechanism for the customization and design of a modular construction unit, or of a modified shipping container construction unit, or of a prefabricated construction unit, wherein the metadata of the said design computing terminal may be inputted or transmitted to 3D-printing computer devices, robotic welding computing devices, computer numerical control (CNC) computing devices, automated painting system computing devices, or modular assembly line computing devices, for the automated fabrication of modular construction units, or of modified shipping container units, or of prefabricated construction units, according to computer readable instructions.
